(19) United States
(12) Patent Application Publication
(10) Pub. No.: US 2016/0092994 A1
(43) Pub. Date: Mar. 31, 2016

(54) COMPUTER PROGRAM, METHOD, AND SYSTEM FOR DETERMINING HOW A TAX EVENT AFFECTS A TAXPAYER'S TAX REFUND OR TAX OWED

(71) Applicant: HRB Innovations, Inc., Las Vegas, NV (US)

(72) Inventors: Eric Roebuck, Shawnee, KS (US); Brenda Hochberg, Brookline, MA (US)

(21) Appl. No.: 14/498,468

(22) Filed: Sep. 26, 2014

(51) Int. Cl. G06Q 40/00

(52) U.S. Cl. CPC G06Q 40/123

(57) ABSTRACT

A computer program, a method, and a system for determining an effect a tax event has on a taxpayer's tax refund amount or tax owed amount (refund/owe amount). During a tax interview for preparation of a tax return using tax preparation software, tax event information related to the taxpayer's liability is inputted. The refund/owe amount is displayed via a refund/owe meter (ROM) on a graphical user interface. After each tax event is inputted or after a ROM generating event, the ROM displays an updated refund/owe amount. Additionally, the effect of the tax event on the displayed amount is presented, including a monetary amount by which a last received tax event affects the displayed amount. The effect is calculated and displayed in real time so as to dynamically change the displayed refund/owe amount in response to the last received tax event information or in response to the ROM generating event.

### BACKGROUND

1. Field

Embodiments of the invention are directed to a method, a system, and a computer program for determining how a tax event affects a taxpayer's tax refund or tax owed. More particularly, embodiments of the invention determine, in real time, how each inputted tax event affects the taxpayer's tax refund or tax owed amount and displays at least one of a monetary amount by which a last inputted tax event affects the tax refund or tax owed amount, a tax event accounting identifying a monetary amount by which each tax event affects the tax refund or tax owed amount, or a category event accounting identifying a monetary amount by which each category of tax events affects the tax refund or tax owed amount.

2. Related Art

Tax return preparation software is commonly used by both tax professionals, such as CPAs, to prepare a tax return, and taxpayers self-preparing their tax return. The tax return preparation software presents a tax interview that comprises a plurality of requests for tax event information. The user inputs tax event information in response to the requests, and based on the inputted tax event information, the tax return preparation software facilitates preparing the taxpayer's tax return.

Some tax return preparation software products provide a refund/owe meter or “ROM” that displays the taxpayer's tax refund or tax owed amount (collectively refund/owe amount). The ROM dynamically changes the displayed refund/owe amount based on cumulative tax information inputted to the tax return preparation software. However, neither the ROM nor the tax return preparation software provides to the user or taxpayer an effect of each tax event, including the last inputted tax event, on the displayed refund/owe amount. An exemplary effect of the tax event is a monetary amount by which the tax event changes the displayed refund/owe amount. Users are required to guess at how each tax event affects their refund or tax owed. Even for an educated user knowledgeable regarding the tax rules and regulations of a government taxing authority in which the tax return is to be filed, it is computationally prohibitive to determine the monetary effect of each inputted tax event in real time as the tax event information is inputted. Moreover, even if all tax event information is known, it is further computationally prohibitive to determine how each tax event affects the overall tax liability of the taxpayer. Again, estimations can be made, but because different tax events affect liability at different percentages, and further because one tax event may affect the impact of a second tax event, it is infeasible for a CPA or other tax professional to provide this information to a taxpayer.

### SUMMARY

Embodiments of the invention are broadly directed to calculating and displaying, in generally real time, an effect a tax event has on a taxpayer's tax refund or tax owed amount. Embodiments may be used in tax return preparation software that presents a tax interview to a user. The tax interview includes a plurality of tax-related requests seeking tax event information. The tax event affects the taxpayer's tax liability and is categorized in one of the following categories: income; adjustments and deductions; credits; and taxes, payments, and penalties.

Tax event information is requested by the tax return preparation software and inputted by a user of the software. After each input of the tax event information, embodiments of the invention calculate the tax refund or tax owed amount (collectively refund/owe amount). The calculation is performed in generally real time immediately upon receipt of the tax event information by the computer program of embodiments of the invention. The refund/owe amount is modified in response to the calculation and displayed on a graphical user interface. Additionally, an effect of each inputted tax event is calculated and displayed. In embodiments, the displayed effect includes a monetary amount by which a last received tax event affects the modified refund/owe amount. As a non-limiting example, embodiments of the invention calculate the monetary amount by which the last inputted tax event affects the refund/owe amount, displays the monetary amount, and provides an explanation of how and why the tax event affected the refund/owe amount. In further embodiments, an individual tax event accounting for each inputted tax event that monetarily affects the refund/owe amount is displayed. In other embodiments, a category tax event accounting for each category of said income; adjustments and deductions; credits; and taxes, payments, and penalties is displayed. The category tax event accounting provides an explanation to the taxpayer of how each category affects the taxpayer's refund/owe amount, and the category tax event accounting is a sum of a monetary amount by which all tax events in the respective category affect the refund/owe amount.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1A is a first flow chart illustrating a first plurality of steps implemented by a computer program, method, and system of embodiments of the invention;

FIG. 1B is a second flow chart illustrating a second plurality of steps implemented by the computer program, method, and system of embodiments of the invention;

FIG. 1C is a third flow chart illustrating a third plurality of steps implemented by the computer program, method, and system of embodiments of the invention;

FIG. 1D is a fourth flow chart illustrating a fourth plurality of steps implemented by the computer program, method, and system of embodiments of the invention;

FIG. 1E is a fifth flow chart illustrating a fifth plurality of steps implemented by the computer program, method, and system of embodiments of the invention;

FIG. 2 is a block diagram illustrating computer-related hardware for implementing embodiments of the invention;

FIG. 3 is a first screen capture depicting a graphical user interface of an embodiment of the invention;

FIG. 4 is a second screen capture depicting the graphical user interface of an embodiment of the invention;

FIG. 5 is a third screen capture depicting the graphical user interface of an embodiment of the invention;

FIG. 6 is a fourth screen capture depicting the graphical user interface of an embodiment of the invention;

FIG. 7 is a fifth screen capture depicting the graphical user interface of an embodiment of the invention;

FIG. 9 is a sixth screen capture depicting the graphical user interface of an embodiment of the invention;

FIG. 10 is a seventh screen capture depicting the graphical user interface of an embodiment of the invention;

FIG. 11 is an eighth screen capture depicting the graphical user interface of an embodiment of the invention; and

FIG. 12 is a ninth screen capture depicting the graphical user interface of an embodiment of the invention.

The drawing figures do not limit the embodiments of the invention disclosed and described herein. The drawings are not necessarily to scale, emphasis instead being placed upon clearly illustrating various features of embodiments of the invention.

### DETAILED DESCRIPTION

The following detailed description references the accompanying drawings that illustrate embodiments of the invention. The embodiments are intended to describe aspects of the invention in sufficient detail to enable those skilled in the art to practice embodiments of the invention. Other embodiments can be utilized and changes can be made without departing from the scope the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Embodiments of the invention comprise a computer program, a method, and a system to calculate, in generally real time and in conjunction with or as part of using tax return preparation software, an effect a tax event has on a taxpayer's tax refund amount or tax owed amount. In general and as discussed in detail below, the tax preparation software presents a plurality of questions requesting tax event information for a taxpayer. The plurality of questions is, in the art, referred to as a tax interview. As the questions are answered and tax event information is inputted to the tax return preparation software, the software displays a running total of a tax refund due to the taxpayer or a tax owed by the taxpayer, collectively a “refund/owe amount.” The refund/owe amount is displayed to the user as a refund/owe meter or “ROM,” and the ROM dynamically changes the refund/owe amount upon a ROM generating event. In embodiments of the invention, a ROM generating event automatically generates a new displayed refund/owe amount, such that the displayed refund/owe amount is recalculated by the computer program of embodiments of the invention upon any one of the following: (1) receipt of pre-defined tax event information; (2) request by the user; (3) receipt of each successively-inputted tax event; or (4) completion of receipt of all tax event information. Embodiments of the invention thus determine the effect each inputted tax event has on the taxpayer's tax liability, and such determination is performed in real time upon a ROM generating event. The determined effect of each tax event is provided to the user in a variety of formats, as discussed below. Embodiments of the invention thus allow the user to identify, in real time during the tax interview and tax return preparation process, the tax events that most significantly impact the taxpayer's refund/owe amount and how each tax event impacts the taxpayer's refund/owe amount. Yet further embodiments of the invention present a report to the user summarizing the effect of each tax event on the refund/owe amount.

The tax return preparation software in which embodiments of the present invention are used may be any software product that facilitates preparation of or otherwise prepares a tax return for a user. The tax return preparation software may include a tax interview that comprises a plurality of questions seeking tax event information related to a plurality of tax events. The user is then guided through the tax interview and the successive requests for tax event information. The tax return preparation software may be ideally used by a user who is self-preparing their tax return, or alternatively, the tax return preparation software may be ideally used by a tax professional, such as a CPA, who is otherwise assisting the taxpayer in preparing the taxpayer's tax return. Thus, embodiments of the invention are not limited to a particular type or user of tax return preparation software. An exemplary tax return preparation software is provided by H&R BLOCK®.

In embodiments of the invention, the tax interview may be broken down into discrete sections seeking discrete items of tax event information. For example, embodiments of the invention may categorize the tax events into the following four categories: income; adjustments and deductions; credits; and taxes, payments, and penalties. The tax interview may then request information for tax events in each of these categories. More or less categories may be used in embodiments. For example, the taxes, payments, and penalties category may be divided into two categories of a taxes and payments category and a penalties category, or three categories of a taxes category, a payments category, and a penalties category. Additionally, the categories may be named differently but comprise the same general type of tax event information. Thus, a name of each category is merely an identifier used for ease of understanding, and embodiments of the invention may be equally applicable to other category names. Moreover, the categories may be named the same or differently and comprise different types of tax event information.

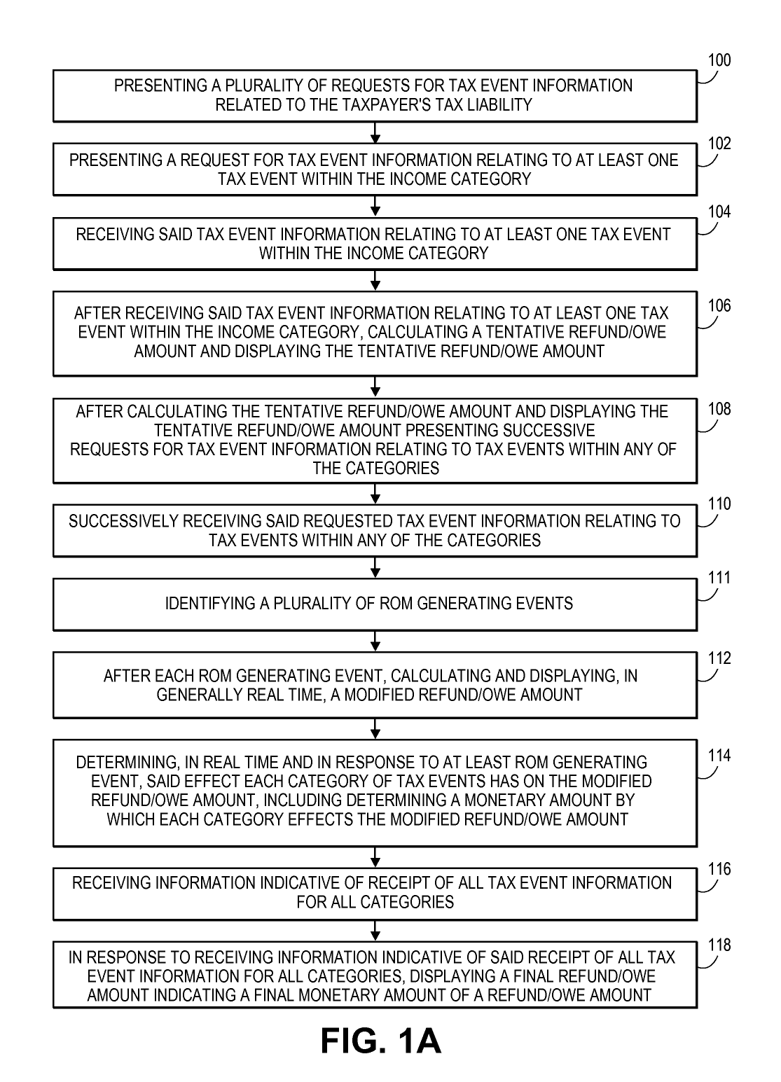

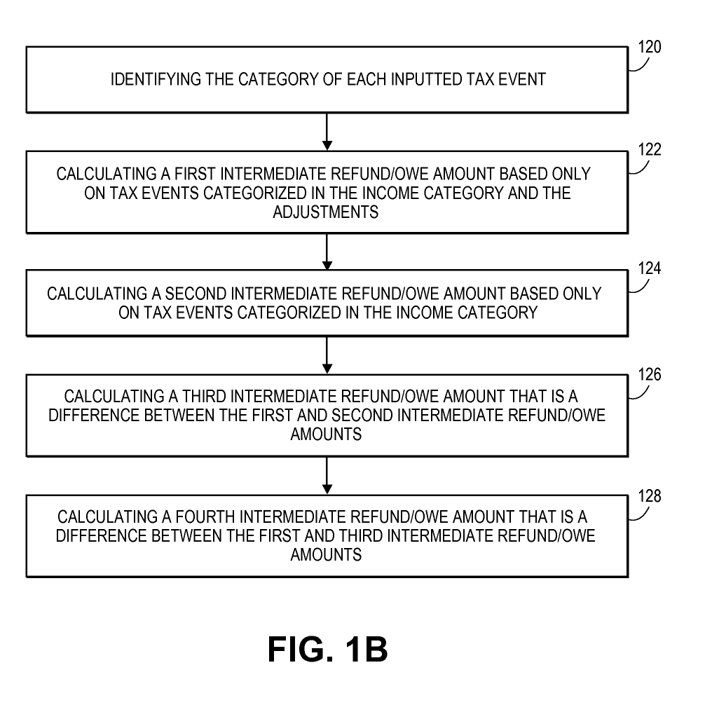

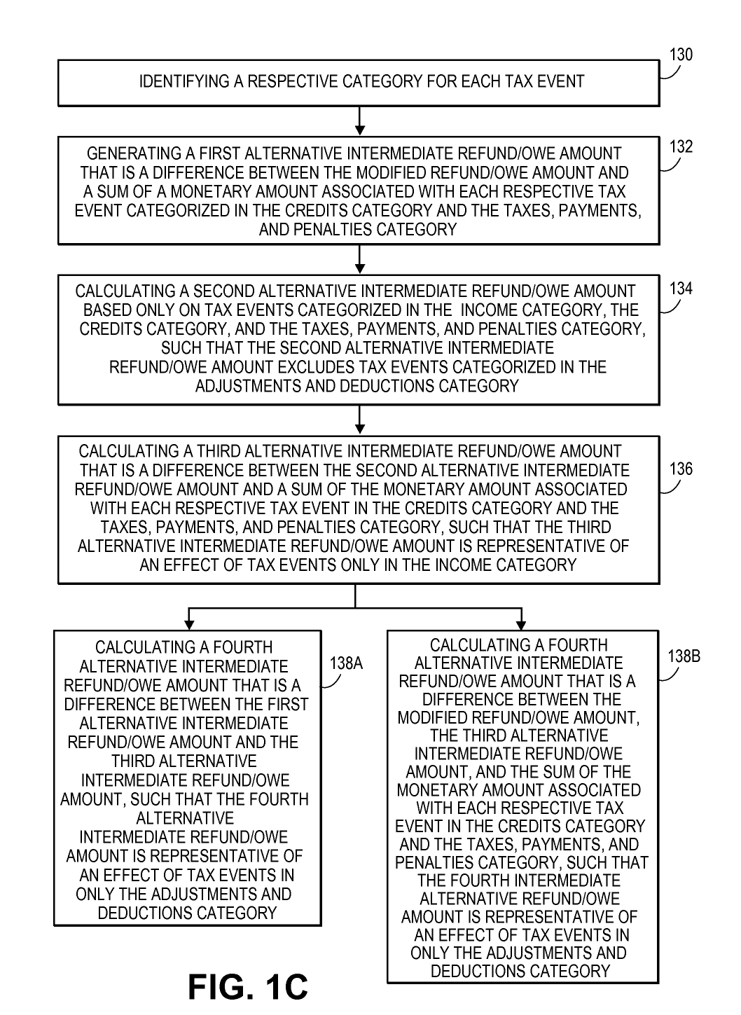

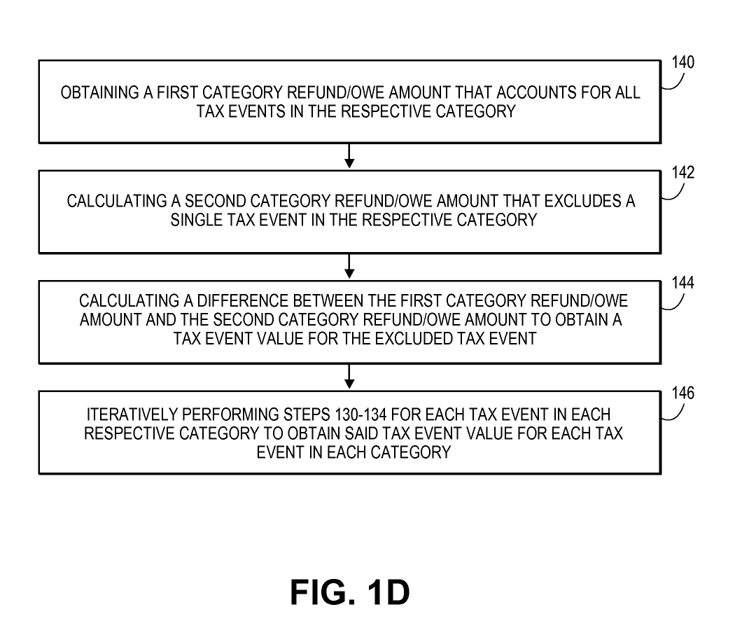

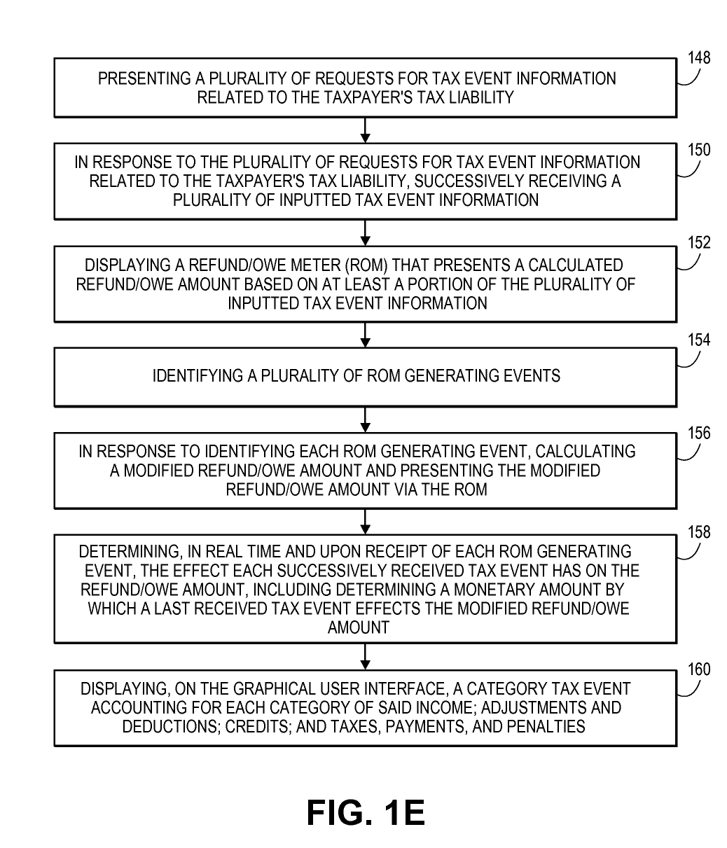

Turning now to FIG. 1A, embodiments of the invention broadly comprise, but do not necessarily require, the steps of presenting, to a user of the computer program of embodiments, a plurality of requests for tax event information related to the taxpayer's tax liability; presenting a request for tax event information relating to at least one tax event within the income category; receiving said tax event information relating to at least one tax event within the income category; after receiving said tax event information relating to at least one tax event within the income category, calculating a tentative refund/owe amount and displaying the tentative refund/owe amount on the interface; after calculating the tentative refund/owe amount and displaying the tentative refund/owe amount on the interface, presenting successive requests for tax event information relating to tax events within any of the categories; successively receiving said requested tax event information relating to tax events within any of the categories; identifying a plurality of ROM generating events; in response to receiving information indicative of at least one ROM generating event, calculating and displaying, in generally real time, a modified refund/owe amount; determining, in real time and in response to receipt of at least one ROM generating event, said effect each category of tax events has on the taxpayer's modified refund/owe amount, including determining a monetary amount by which each category of tax events affects the modified refund/owe amount; receiving information indicative of receipt of all tax event information for all categories; and in response to receiving information indicative of said receipt of all tax event information for all categories, displaying a final refund/owe amount indicating a final monetary amount of a refund/owe amount.

It should be appreciated that other embodiments of the invention may perform some or all of the above-listed steps and/or may perform different steps or in a different order. Thus, for example, embodiments of the invention may perform the steps set forth in FIG. 1E. In particular, at step 148, embodiments of the invention may present, via a graphical user interface, a plurality of requests for tax event information related to the taxpayer's tax liability. In response to the plurality of requests for tax event information related to the taxpayer's tax liability, a plurality of inputted tax event information is successively received, as set forth in step 150. At step 152, the computer program displays, via the graphical user interface, a refund/owe meter (ROM) that presents a calculated refund/owe amount based on at least a portion of the plurality of inputted tax event information. The computer program continually monitors the received information and inputs from the user and the calculations performed by the program to identify a plurality of ROM generating events, as set forth at step 154. In response to identifying each ROM generating event, a modified refund/owe amount is calculated, and the amount is displayed via the ROM at step 156. In embodiments of the invention, the modified refund/owe amount is based on a cumulatively entered tax event information, that is the tax event information entered to date in the program. Next, in real time and upon receipt of each ROM generating event, said effect each successively received tax event has on the refund/owe amount is determined, as set forth in step 158. Determining said effect includes determining a monetary amount by which a last received tax event effects the modified refund/owe amount. In embodiments of the invention and shown at step 160, a category tax event accounting is displayed on the graphical user interface for each category of the income; adjustments and deductions; credits; and taxes, payments, and penalties categories. The category tax event accounting provides an explanation to the taxpayer of how each category affects the taxpayer's refund/owe amount. The category tax event accounting is a sum of a monetary amount by which all tax events in the respective category affect the refund/owe amount. In yet other embodiments, and individual tax event accounting for each tax event affecting the refund/owe amount is also displayed to the user.

Embodiments of the invention provide a technical advance in quickly calculating an effect of a particular tax event on a taxpayer's tax refund or tax owed amount. The steps of embodiments of the invention are not capable of being performed without implementation via the computer program; that is, a human would not be able to perform the steps of embodiments in real time, as such would be computationally prohibitive. Additionally, embodiments of the invention address the technical problem of identifying how particular tax events affect a taxpayer's tax refund/owe amount when using tax return preparation software. Because the tax return preparation software commonly implements a tax interview to obtain the tax event information, the user is never provided any information on how the tax refund/owe amount is affected by subsequent tax events. The solution of embodiments of the invention is to overcome the technical deficiencies of the prior art's simple display of a tax refund/owe amount only by providing the user with additional information on why the tax refund/owe amount was changed in view of inputted tax event information. Moreover, this additional information of an effect a tax event has on the refund/owe amount is provided in real time as the user is inputting the tax event information, which advantageously correlates for the user the particular tax event to the changed refund/owe amount as the user progresses through the tax interview.

### System and Hardware Overview

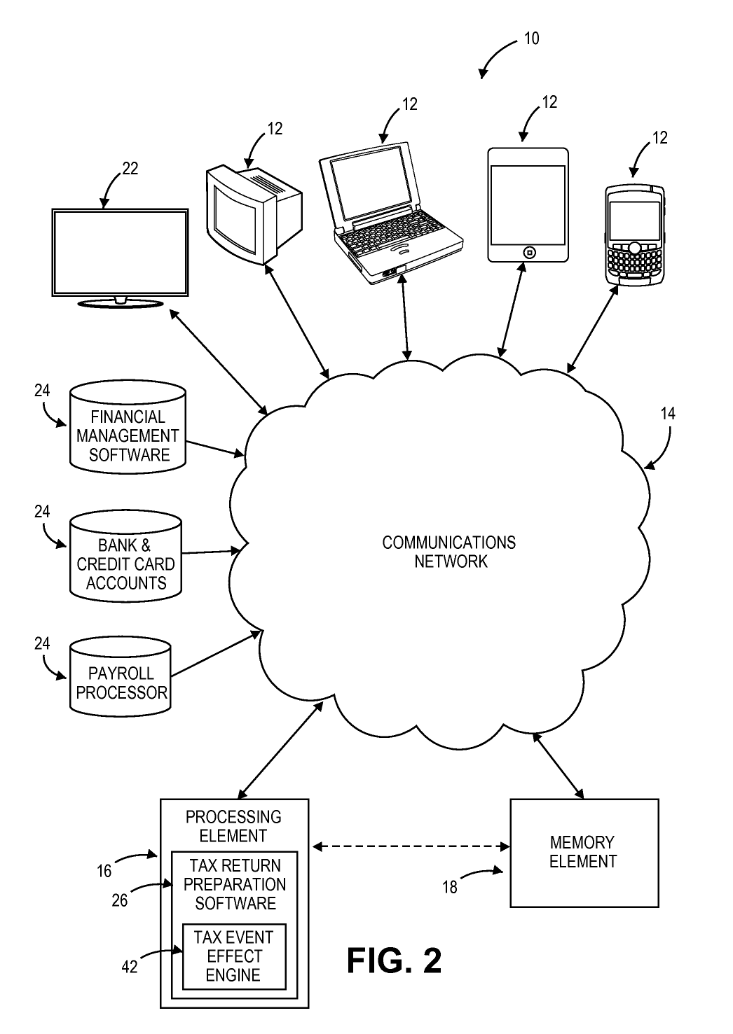

The computer program of embodiments of the invention implements various steps of the method of embodiments of the invention when executed by a computing device (which may also be referred to herein as a computing element). As shown in FIG. 2, the system 10 of embodiments of the invention may comprise computing devices to facilitate the functions, features, and steps executed by the computer program, performed by the method, and otherwise described herein.

The computer program of embodiments of the invention comprises a plurality of code segments executable by a computing device 12 for performing the steps of various methods of the invention. The steps of the method may be performed in the order shown in FIGS. 1A and 1B, or they may be performed in a different order, unless otherwise expressly stated. Furthermore, some steps may be performed concurrently as opposed to sequentially. Also, some steps may be optional. The computer program may also execute additional steps not described herein. The computer program, system, and method of embodiments of the invention may be implemented in hardware, software, firmware, or combinations thereof, which broadly comprises server devices, computing devices 12, and a communications network 14.

The computing devices 12 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system 10. The computing devices 12 may include mobile communication devices (including wireless devices), work stations, desktop computers, laptop computers, palmtop computers, tablet computers, portable digital assistants (PDA), smart phones, and the like, or combinations thereof. As discussed herein, the computer program of embodiments of the invention may be responsive to user input. The computing devices 12 may receive user input from a variety of sources, including but not limited to, the following: keyboards, keypads, mice, trackpads, trackballs, pen-input devices, printers, scanners, facsimile, touchscreens, network transmissions, verbal/vocal commands, gestures, button presses or the like. Various embodiments of the computing device 12 may also include voice communication devices, such as cell phones and/or smart phones.

The server devices and computing devices 12 may include any device, component, or equipment with a processing element 16 and associated memory elements 18. The processing element 16 may implement operating systems, and may be capable of executing the computer program, which is also generally known as instructions, commands, software code, executables, applications (“apps”), and the like. The processing element 16 may include processors, microprocessors, microcontrollers, field programmable gate arrays, and the like, or combinations thereof. The memory elements 18 may be capable of storing or retaining the computer program and may also store data, typically binary data, including text, databases, graphics, audio, video, combinations thereof, and the like. The memory elements 18 may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), and the like, or combinations thereof. In addition to these memory elements 18, the server devices may further include file stores comprising a plurality of hard disk drives, network attached storage, or a separate storage network.

In embodiments, the computing device 12 will have an electronic display 22 operable to display visual graphics, images, text, etc. In embodiments, the computer program facilitates interaction and communication through a graphical user interface (GUI) that is displayed via the electronic display. The GUI enables the user to interact with the electronic display by touching or pointing at display areas to provide information to the system 10.

The communications network 14 may be wired or wireless and may include servers, routers, switches, wireless receivers and transmitters, and the like, as well as electrically conductive cables or optical cables. The communications network 14 may also include local, metro, or wide area networks, as well as the Internet, or other cloud networks. Furthermore, the communications network 14 may include cellular or mobile phone networks, as well as landline phone networks, public switched telephone networks, fiber optic networks, or the like.

The computer program may run on computing devices 12 or, alternatively, may run on one or more server devices. In embodiments of the invention, the computer program may be embodied in a stand-alone computer program (i.e., an “app”) downloaded on a user's computing device 12 or in a web-accessible program that is accessible by the user's computing device 12 via the communications network 14. As used herein, the stand-alone computer program or web-accessible program provides users with access to an electronic resource from which the users can interact with various embodiments of the invention.

The code segments and any corresponding source code forming the computer program may serve to implement tax return preparation software 26. The tax return preparation software 26 is shown as being executed by the processing element 16 in FIG. 2, although it should be appreciated that some or all of the code segments forming the tax return preparation software may be stored on one or more memory elements 18 and may be executed by at least one computing device 12.

Embodiments of the invention may allow for the taxpayer to create and access a taxpayer profile. The taxpayer or other user may edit, revise, populate, or otherwise modify the taxpayer profile with tax event information related to the taxpayer. Additionally, the taxpayer may upload to, save, or otherwise associate the taxpayer profile with a source of known tax event information 24, as shown in FIG. 2. For example, the taxpayer may associate the taxpayer profile with a plurality of sources of known tax event information 24, such that the taxpayer profile is populated with known tax event information automatically and electronically pulled from the plurality of sources 24. Exemplary sources of known tax event information 24 include, without limitation, financial management software, bank and credit card accounts for the taxpayer, investment accounts for the taxpayer, an existing account with a tax professional, a payroll processor, a previously filed tax return, a W-2 for the taxpayer, a pay stub, or receipts that are electronically scanned.

As an example, the tax return preparation software 26 may pull or otherwise automatically receive tax event information from the plurality of sources 24. This tax event information may be saved to the taxpayer profile for use in preparing the tax return. Alternatively, the taxpayer or other user may manually enter the tax event information into the tax return preparation software. For example, in the computer program of embodiments of the invention, known tax event information may be provided directly from the taxpayer or other user through the GUI by allowing the taxpayer/user to enter tax event information via the computer program. In general and in addition to the above, the source of known tax event information 24 may include any one of the above plurality of sources, a database of tax event information, or any combination thereof. Furthermore if the embodiment is associated with an electronic source of known tax event information (e.g., a bank account, financial management software, etc.), the taxpayer profile may continuously update the known tax event information as new or changed information is associated with the respective source of tax event information.

Embodiments of the invention are ideally suited, although not required, for use with tax return preparation software 26. As such, embodiments of the invention provide a tax event effect engine 42 that performs the steps described herein and illustrated in FIGS. 1A-1D. The tax event effect engine 42 may be implemented by the computer program of embodiments of the invention. In turn, the computer program may be implemented via the electronic resource, such as a website or an app described above. Although not required, the taxpayer profile may be accessed via an authentication process, such as requiring a username and passcode.

### Discussion of Particular Terms

The “taxpayer” as used herein is a person or entity for which a tax return is prepared. The taxpayer may comprise multiple persons, such as the case of a married couple filing jointly. Alternatively, the taxpayer may be an entity, such as a business. It is contemplated that a user of embodiments of the invention may not be the taxpayer himself or herself, such as may be the case if the user is acting on behalf of or at the direction of the taxpayer. Therefore, use of the term “taxpayer” herein is intended to encompass either or both of the taxpayer and any third party operating on behalf of the taxpayer. Additionally, a taxpayer may comprise an individual filing singly, a couple filing jointly, a business, or a self-employed filer.

A “tax event” is any action, inaction, or other circumstance, taken or not taken by either the taxpayer or a third party, that will have an effect on or otherwise be germane to either of preparation of a tax return for the taxpayer or the taxpayer's tax liability. “Tax event information” is the quantitative information associated with the tax event. For example, if the tax event is income received from an employer, then the tax event information associated with the tax event may be the name of the employer, the employer FID, and an income paid by the employer. It is noted that tax events include, but are not necessarily limited to, events that affect the taxpayer's tax liability. For example, a tax event may include the taxpayer's address, and the tax event information is the actual address of the taxpayer. This is a circumstance that is germane to preparation of the tax return (and, in some cases, may affect the taxpayer's tax liability). An exemplary, non-exhaustive list of tax events is the following: name, social security number, age, marital status, sex, address, country of residence, state of residence, state of employment, employer name and location, occupation/profession/trade, income, business expenses, tax bracket, prior tax returns, deductions, insurance coverage, number of dependents, dependent's information, dependent's income, student loan information, taxable property information, investment information, prior or current W-2s, prior and/or current income tax withholdings to date, purchases, or other information germane to calculating the taxpayer's tax liability.

The taxpayer's “tax liability” is a monetary amount of taxes to be paid by the taxpayer for a tax period, e.g., a tax year. As is common, taxes may be withheld, e.g., via income tax withholdings, throughout the tax period. Thus, the actual amount of tax owed at the end of the tax period and upon preparing and filing the tax return may be far less than the taxes to be paid for the tax period. In some cases, as can be appreciated, the taxpayer may have a tax liability but have withheld more than required throughout the tax period via income tax withholdings to satisfy the tax liability. In such a case, the taxpayer is due a tax refund upon completing and filing the tax return.

The tax liability is based on tax rules and regulations set by a government taxing authority. The government taxing authority as used herein may be any local, state, or national government or agency that has an ability to levy a tax on a taxpayer. The taxpayer's tax liability will depend on several factors including, but not limited to, the following: the taxpayer's taxable income, dependents, allowances, deductions, filing as a single taxpayer, filing jointly with another individual, charitable contributions, retirement savings, educational loans, etc. Every tax period (e.g., every tax year), the taxpayer must file a tax return to report and satisfy their tax liability. A tax return may be prepared by the taxpayer, such as by using self-preparation tax software, by a tax professional, or by a taxpayer representative. Although embodiments of the invention provide tax return preparation software that assists the user in preparing the tax return and further informs the user of the effect of a tax event on a refund/owe amount, embodiments of the invention do not change the taxpayer's overall tax liability or otherwise reduce, avoid, or defer the taxpayer's tax liability for the tax period. That is, the taxpayer's tax liability remains the same based on the rules and regulations of the government taxing authority.

### Operation of Embodiments of the Invention

As briefly discussed above, embodiments of the invention are particularly suited, although not necessarily required, for use with tax return preparation software. Moreover, embodiments of the invention may be used with any tax return preparation software, including any brand of software and for use by both tax professionals and self-preparers (i.e., taxpayers who prepare their tax returns themselves). Yet further, embodiments of the invention are particularly suited, although not necessarily required, for use with tax return preparation software that presents a tax interview to the user for facilitating entry or receipt of the tax event information. The tax interview commonly includes a plurality of requests for tax event information.

As discussed briefly above, embodiments of the invention dynamically calculate and display a refund/owe amount in response to a ROM generating event. As used herein, “dynamically” encompasses a generally real time change. “Real time” as defined herein is when the processing element of the system 10 performs the steps less than every 1 second, every 500 milliseconds, every 100 milliseconds, or every 16 milliseconds. Thus, it should be appreciated that the ROM is displaying the refund/owe amount generally immediately subsequent to receipt of a ROM generating event.

In embodiments of the invention, the ROM generating event may be any of the following: (1) receipt of pre-defined tax event information; (2) request by the user; (3) receipt of each successively-inputted tax event; or (4) completion of receipt of all tax event information. Referring to “(1) receipt of pre-defined tax event information,” embodiments of the invention pre-define certain tax events for automatic generation of an updated refund/owe amount. In general, some tax events commonly do not affect a refund/owe amount at all or do not appreciably affect the refund/owe amount, such that calculation of the refund/owe amount by the computer program of embodiments is either unnecessary or of limited benefit to the taxpayer. In such a case, embodiments of the invention do not calculate the updated refund/owe amount and display via the ROM after receipt of each tax event. Instead, such embodiments only calculate the updated refund/owe amount upon the tax event being a ROM generating event. Exemplary, although not exhaustive, pre-defined tax events that are ROM generating events include the following: after receipt of any tax credit; after receipt of any itemized deduction (e.g., real estate taxes, IRA contributions, medical expenses, charitable donations); after receipt of any or all information for a tax form or schedule (e.g., a Schedule C); after receipt of paid alimony, casualty or theft, or adoptions expenses, etc.

Referring to “(2) request by the user” and as described below, embodiments of the invention provide an option to the user to view the details of the refund/owe amount currently being displayed. One of the ROM generating events is thus the user affirmatively requesting to review the details of the refund/owe amount. Another exemplary “request by the user” is selection, by the user, of a “generate ROM” input or other similar indicator. For example, embodiments of the invention may present on the GUI a selectable link that upon selection by the user automatically calculates the refund/owe amount based on the tax event information inputted to date. Referring to “(3) receipt of each successively-inputted tax event,” in embodiments of the invention the refund/owe amount is recalculated upon receipt of each inputted tax event, such that the ROM automatically displays the refund/owe amount for all inputted tax events to date. Thus, the computer program of embodiments of the invention is calculating the updated refund/owe amount upon receipt of each successively-inputted tax event. Finally, referring to “(4) completion of receipt of all tax event information,” embodiments of the invention will calculate the refund/owe amount after receiving all tax event information. Completion of entry by the user of all tax event information may be known by the computer program based on a user indication that all tax event information is entered or completion of presenting to the user all requests for tax event information.

In embodiments of the invention, automatic calculation of the refund/owe amount in response to receipt of a ROM generating event is based on all received tax event information at the time of the ROM generating event. As an example, if the taxpayer has inputted tax event information for ten tax events, and then a ROM generating event occurs, the calculated refund/owe amount is based on the inputted ten tax events. Reference to generating the ROM or calculating the refund/owe amount “to date” should be understood to be, in embodiments of the invention, based on all entered tax event information as of the time of performing the calculation of the refund/owe amount.

As briefly noted above, the tax interview is presented on a graphical user interface (“GUI”) that is displayed on a display, such as a screen of the computing device 12. Embodiments of the invention present information to the user via the GUI. The user may then actuate the input to enter tax event information responsive to the requests for tax event information. Reference below to steps of presenting requests, information, etc. is understood to be presenting on the GUI, unless otherwise expressly stated. The inputted information is then received by the computer program and processed according to embodiments of the invention.

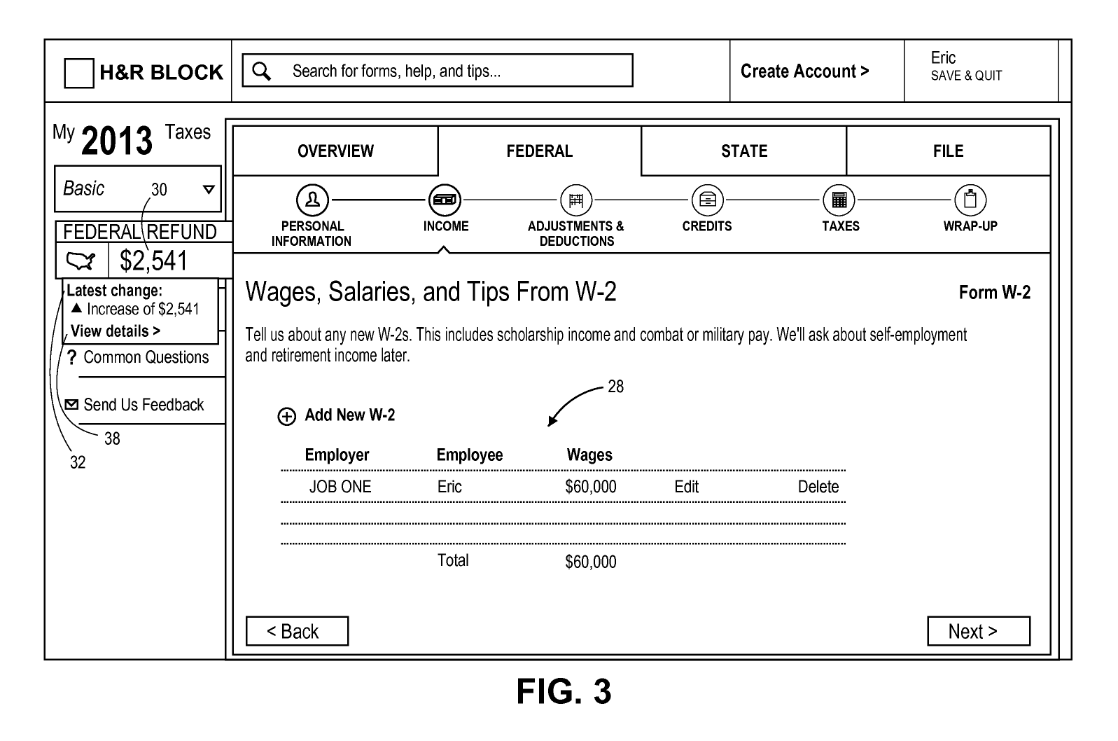

Referring now to step 100 of FIG. 1A, embodiments of the invention present a plurality of requests for tax event information to the user. At least some of the requested tax event information is related to the taxpayer's tax liability. As noted above, the plurality of requests for tax event information may collectively be referred to as or otherwise embodied in the tax interview. The taxpayer's tax liability is affected by, at least in part, at least some of the tax event information, such that the tax event information is related to the taxpayer's tax liability. Exemplary requests for tax event information include, without limitation to the wording, “Wages, Salaries, and Tips From W-2,” as illustrated in FIG. 3, or “Enter Any Dependents.”

The tax interview commonly presents the request for information in a particular order. The user may optionally enter tax event information in a different order than the requests are presented by the tax interview. The user may skip certain requests and come back to them at a later time. Thus, unless otherwise expressly stated herein, an order of inputting tax event information is not intended to be limiting. In embodiments of the invention, the tax interview is divided into the following categories of tax event information: income; adjustments and deductions; credits; and taxes, payments, and penalties. Thus, the tax interview guides the user through the income requests for tax information, the adjustments and deductions requests for tax information, etc.

Referring now to step 102, a request for tax event information relating to at least one tax event within the income category is presented on the GUI, and the requested information is inputted by the user and otherwise received by the computer program, as set forth in step 104. Although other tax event information may be obtained prior to obtaining income events, in embodiments of the invention the ROM will not display a refund/owe amount until at least some income information is inputted to the tax return preparation software 26. In other embodiments and based on the taxpayer's circumstances, the refund/owe amount may be generated absent any income tax event information being inputted. For example, under the Affordable Care Act, there may be instances where the taxpayer is due a credit even if the taxpayer has no income to input. Other information that may be obtained prior to obtaining income events includes, without limitation, name, social security number, address, and occupation. Thus, embodiments of the invention do require entry of some income information prior to displaying a refund/owe amount that is any monetary value other than $0 or that is otherwise accurate. However, in other embodiments of the invention, the user may enter tax event information that is not in the income category before any income tax event information is entered, and the computer program will display a refund/owe amount based on the non-income tax event information.

After receiving the tax event information relating to the taxpayer's income, embodiments of the invention calculate a tentative refund/owe amount and display this amount on the GUI, as set forth in step 106. In embodiments of the invention, the tentative refund/owe amount is the first non-$0 amount displayed by the ROM and is in response to receipt of income tax event information from the user (or a credit not requiring income). The tentative refund/owe amount is not considered the final refund/owe amount for most cases. There may be instances where the taxpayer's tax return is so simple that no other tax events other than a single income tax event affects the taxpayer's refund/owe amount, although this would be very rare. Instead, the vast majority of taxpayers' tax returns will include multiple items of tax event information that each affects the refund/owe amount. Thus, upon receipt of a ROM generating event, the refund/owe amount will dynamically change to reflect the received tax event information to date.

The refund/owe amount as described herein (and any tentative or intermediate refund/owe amount described herein) is calculated based on the tax rules and regulations of the government taxing authority in which the tax return is to be filed. Thus, the refund/owe amount reflects what the tax refund or tax owed is based on the cumulative tax event information inputted to the tax return preparation software. Although calculation of the refund/owe amount is a step of embodiments of the invention, no claim is made herein to calculating the refund/owe amount based on and applying the government taxing authority's rules and regulations. Instead, embodiments of the invention provide the monetary amount by which the refund/owe amount changed in response to the last received tax event information or since the last ROM generating event, explain to the user why the refund/owe amount changed, to the extent it did, and explain how the tax event information affected the change.

After calculating the tentative refund/owe amount and displaying the amount on the GUI, the user is guided through the tax interview and successive requests (i.e., one request after another) for tax event information relating to any of the tax event information categories, as set forth in step 108. The user then inputs the tax event information, which is successively received by the computer program, as set forth in step 110. Thus, to determine any refund/owe amount, at least some tax event information must first be inputted, as described above. In embodiments, at least some income tax event information must first be inputted (or a credit not requiring income). However, after income information is received, the user may be presented requests for tax event information from any of the categories. Unless the user selectively jumps to different categories within the tax interview, most tax interviews will present the requests for tax event information in a pre-set order as established by the tax return preparation software 26. Moreover and as should be appreciated, the requests for tax event information may be different for different taxpayers based on a taxpayer's particular tax situation.

As noted above, ROM generating events may occur throughout the tax interview. For example, the computer program may receive tax event information of a type that automatically generates the refund/owe amount. Alternatively, the user may request to view the details of the displayed ROM. Thus, embodiments of the invention continually monitor received inputs from the user and from the calculations and decisions performed by the computer program to identify at least one of, and in embodiments a plurality of, ROM generating events, as set forth in step 111. After each ROM generating event, embodiments of the invention calculate and display, in generally real time, a modified refund/owe amount in the ROM, as set forth in step 112. In further detail, after the tentative refund/owe amount is calculated and displayed, as set forth in step 106, at least one subsequent request for tax event information is presented to the user (step 108) and tax event information is received in response to the request (step 110). Upon receipt of another ROM generating event, the computer program calculates a new refund/owe amount based on the received tax event information to date, and thus, the refund/owe amount is modified relative to the tentative refund/owe amount. In embodiments of the invention that calculate the refund/owe amount after each successively-inputted tax event (i.e., embodiments where a ROM generating event is input of any tax event information), the ROM will continuously display the latest modified refund/owe amount. For any ROM generating event, the displayed modified refund/owe amount is based on all inputted tax event information to date; that is, the displayed modified refund/owe amount includes the last received tax event information, in addition to any prior-received tax event information. The modified refund/owe amount dynamically changes in generally real time in response to a ROM generating event.

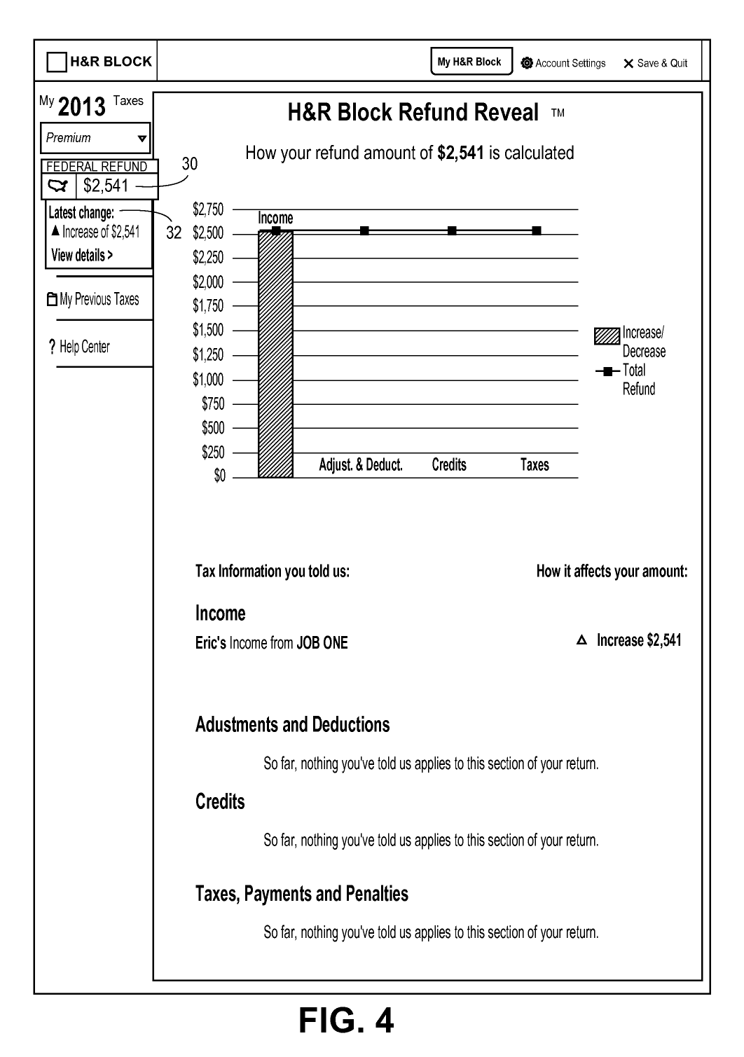

As set forth in step 114, embodiments of the invention determine, in real time and in response to receipt of at least one ROM generating event or upon receipt of each ROM generating event, an effect each category of tax events or, in embodiments, each tax event, has on the modified refund/owe amount. The determined effect includes a monetary amount by which the category of tax events or, in embodiments, each tax event, changes or otherwise affects the modified refund/owe amount as compared to either the last ROM generating event or the last inputted tax event. For example, and as shown in FIG. 4, embodiments of the invention display an indication of a monetary change in the displayed refund/owe amount as compared to a last change of the displayed refund/owe amount. Additionally, the user may selectively choose to view more information about the change in the modified refund/owe amount, as discussed below. The substeps performed by the computer program for determining the effect of each ROM generating event on the modified refund/owe amount are described below and in reference to FIG. 1B.

Other embodiments of the invention determine, in real time and in response to receipt of at least one ROM generating event or upon receipt of each ROM generating event, an effect each category of tax events has on the taxpayer's modified refund/owe amount is determined. The determined effect includes a monetary amount by which each category of tax events affects the modified refund/owe amount. Thus, for example, some embodiments determine the effect of each tax event on the modified refund/owe amount, other embodiments determine the effect of each category of tax events on the modified refund/owe amount, and yet further embodiments determine both the effect of each tax event and each category of tax events on the modified refund/owe amount.

Turning again to FIG. 1A and step 116, once the user has inputted all tax event information or otherwise responded to each of the tax interview's requests for tax information, embodiments of the invention will receive information indicative of receipt of all tax event information for all categories. For example, the tax return preparation software may present a question to the user asking if the user has any further tax event information to provide, or the tax return preparation software may know that all tax event information is inputted upon completing the tax interview. Thus, the information indicative of receipt of all tax event information for all categories is an instruction to the computer program that a final refund/owe amount is to be calculated and displayed, to the extent not otherwise already calculated and displayed. In response to receiving the indication of completion of all inputting of tax event information, the final refund/owe amount is displayed, as indicated at step 118.

In further embodiments of the invention and as illustrated in FIGS. 4, 6, and 8, the computer program may display on the GUI an individual tax event accounting for each individual tax event inputted to the computer program to date and/or each individual tax event that affects the monetary amount of the final refund/owe amount. In embodiments, only those tax events that affect the monetary amount may be displayed to the user. As shown, the tax events are divided into the respective categories, such as credits, adjustments and deductions, and income. In the example illustrated in FIG. 4, there is no tax event information in the adjustments and deductions category, the credits category, and the taxes, payments, and penalties category that affects the refund/owe amount.

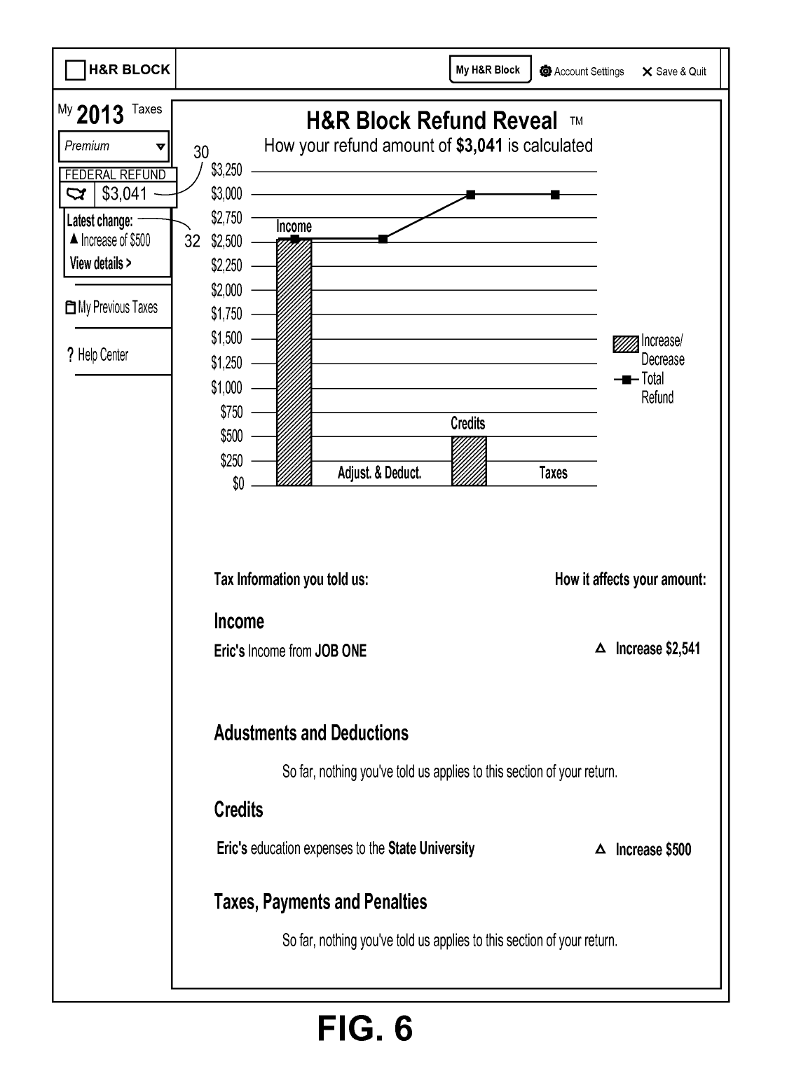

The individual tax event accounting provides an explanation to the taxpayer of how each tax event affects the taxpayer's final refund/owe amount. In alternative embodiments, the individual tax event accounting provides an explanation for the modified refund/owe amount presently displayed. The explanation may include an identification of the tax event and a monetary amount by which the individual tax event information changes the tax refund/owe amount. For example, and referring to FIG. 6, a credit of $500 was applied to the modified refund/owe amount currently being displayed, and the $500 credit was for education expenses. The explanation of the effect on the refund/owe amount for the individual tax event may be presented in a graph, via an instructional text, or a combination thereof, as further discussed below. The displayed explanation may also compare the tax event for the current tax period against prior year tax returns. For example, the effect of student loan interest from a prior tax period may be compared to the present tax period.

In further embodiments of the invention and as illustrated in FIGS. 4, 6, and 8, the computer program may display on the GUI a category tax event accounting for each category of tax event information, e.g., for income; adjustments and deductions; credits; and taxes. The category tax event accounting provides an explanation to the taxpayer of how each category affects the taxpayer's final refund/owe amount. In alternative embodiments, the category tax event accounting provides an explanation for the modified refund/owe amount presently displayed. The category tax event accounting may be displayed in replace of or in addition to the individual tax event accounting.

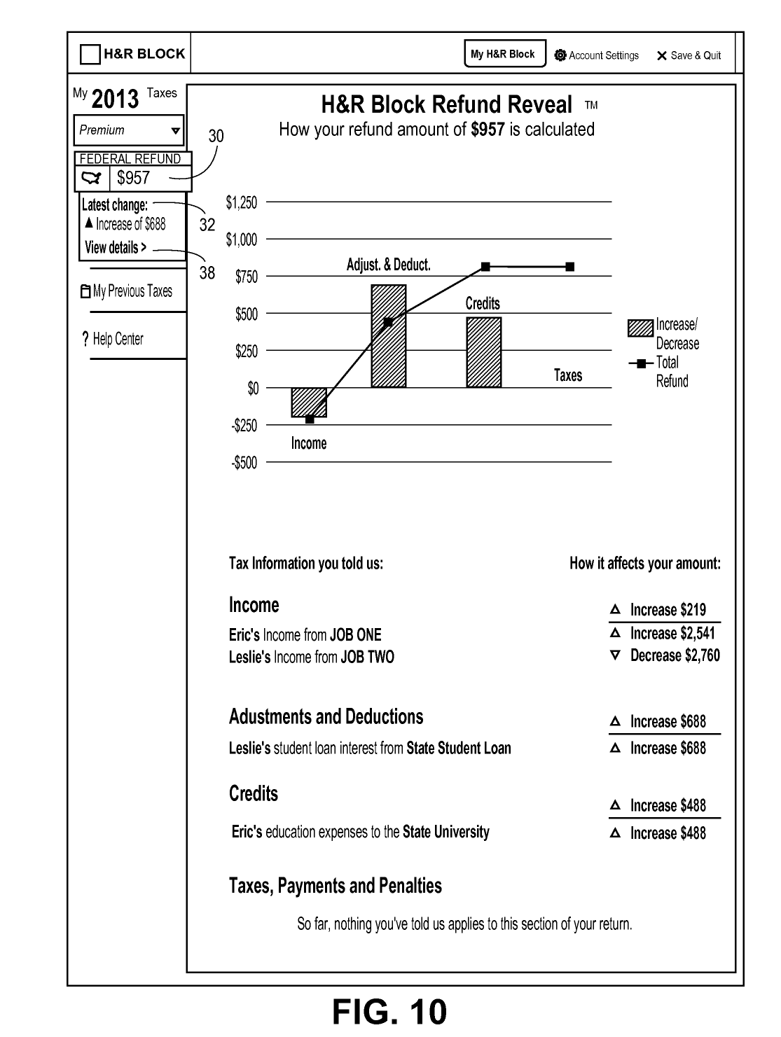

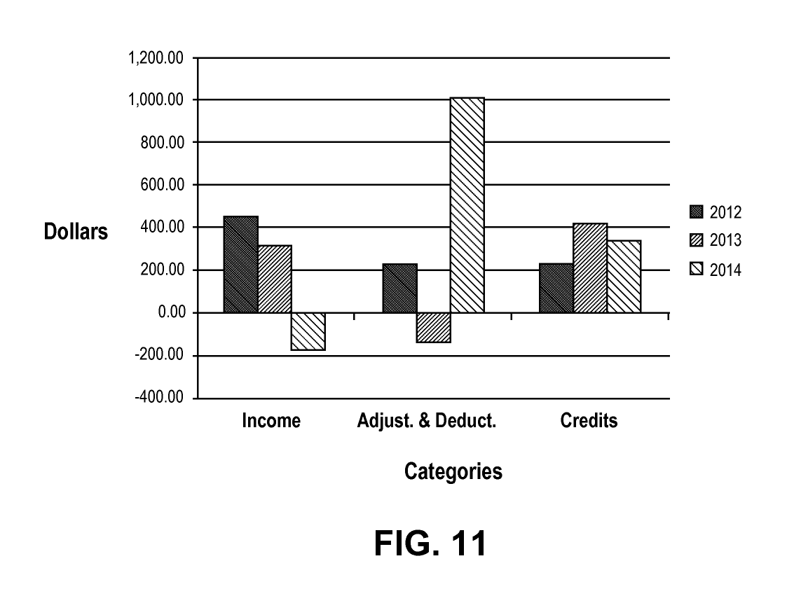

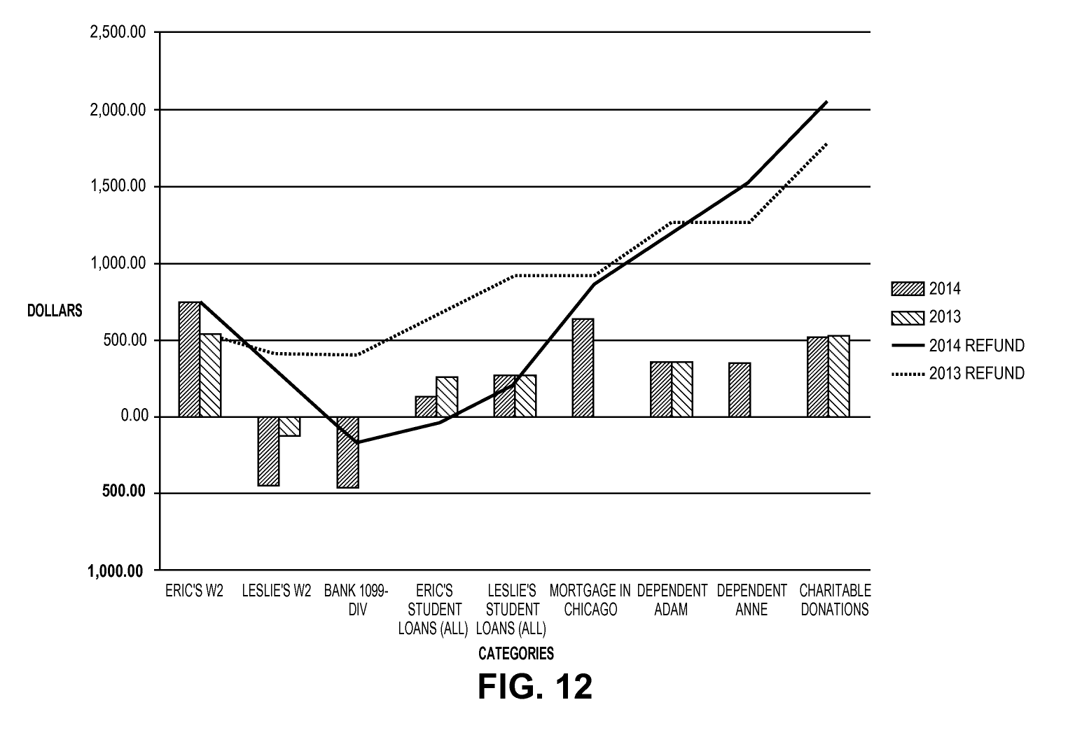

The explanation provided by the category tax event accounting may include a monetary amount by which the category of tax event information changes the tax refund/owe amount. Additionally, the explanation may be presented in a graph, such as a bar graph, a line graph, or a combined bar and line graph, as shown in FIGS. 4, 6, 8, and 11-12. The displayed explanation may also compare the current tax period's refund/owe amount to prior year tax returns, as shown in FIGS. 11 and 12. Yet a further explanation, as illustrated in FIGS. 4, 6, and 8, may include for each category what tax event information caused the respective change in the final tax refund/owe amount. For example, and referring to FIG. 10, the incomes from Job One and Job Two and the corresponding individual effect (e.g., $2,541 for Job One and $2,760 for Job Two) along with the category effect ($219 total for income category) are illustrated. Thus, the explanation to the taxpayer of how each category affects the taxpayer's final refund/owe amount includes a graphical view, a monetary amount, and an identification of the particular tax event.

Turning now to FIG. 1B, the steps for determining a monetary amount by which each tax event affects the modified refund/owe amount are now described. In general, it is computationally prohibitive to determine the monetary effect of each inputted tax event in real time during preparation of the tax return without using a computing device 22. This is because for each inputted tax event, the effect on the refund/owe amount is potentially dependent on other inputted tax event information. As a high-level example before the individual steps are discussed, assume the taxpayer is single and has an income of $78,000. The taxpayer also paid student loan interest of $3,000 and had higher education expenses of $10,000. The tax rules and regulations of the government taxing authority allow for a tax deduction of up to $4,000 of higher education expenses and a tax deduction of student loan interest of up to $2,500, but only if the taxpayer's adjusted gross income (AGI) is less than $75,000. Upon the taxpayer inputting their income, the displayed refund/owe amount is a first amount. If the taxpayer next inputs tax event information for student loan interest, the refund/owe amount does not change. This is because the taxpayer's AGI at the point of time in the tax interview is being calculated as $78,000, i.e., the taxpayer's income. For purposes of this example, the taxpayer then inputs the higher education expenses of $10,000. Because the taxpayer is allowed to deduct up to $4,000 of the higher education expenses from the taxpayer's AGI, the taxpayer's AGI is reduced to $74,000. The computer program then calculates and displays a second refund/owe amount. Based on the last inputted tax event, i.e., the higher education expenses, the taxpayer may be incorrectly led to believe that the second refund/owe amount is a direct byproduct of the inputted higher education expenses. However, in this exemplary scenario, because the $4,000 credit for higher education expenses reduced the taxpayer's AGI to $74,000, the taxpayer is then able to claim the student loan interest deduction of $2,500. Consequently, the second refund/owe amount now being displayed by the computer program, and particularly, the monetary amount change for the first refund/owe amount, is dependent on both the student loan interest deduction and the higher education expenses credit. Embodiments of the invention track and calculate the effect of each of these inputted tax events on the displayed refund/owe amount. It is noted that the above example and any other example provided herein are intended to be generalized examples that do not necessarily accurately reflect application of the tax rules and regulations of any government taxing authority and instead are intended only for reference to the invention.

Thus, to determine the effect of each individual tax event on the modified refund/owe amount, embodiments of the invention first determine an effect each category of tax events has on the modified refund/owe amount. Alternatively, embodiments of the invention may skip categorizing each tax event and first determining an effect of each category of tax events, and instead use the algorithm discussed below but for each individual tax event or, at the least, each ROM generating event that is a tax event.

Returning to FIG. 1B and as yet further explanation on why determining the effect of each received tax event in real time is computationally prohibitive without use of the computing device, determining this effect requires identifying the category of each inputted tax event and isolating all inputted tax events for each category, as set forth in step 120 of FIG. 1B. In particular, the government taxing authority's tax rules and regulations commonly do not treat each tax event equally. For example, if the tax event is a credit, then this category of tax events usually lowers the taxpayer's refund/owe amount dollar-for-dollar, i.e., if the tax credit is $1,000, then the refund/owe amount is increased by $1,000. Alternatively, if the tax event is a deduction, then this type of tax event lowers the taxable income. For example, if the taxpayer's adjusted gross income (“AGI”) is $30,000, the taxpayer makes a charitable contribution of $2,000, and the tax rules and regulations of the government taxing authority allow a 50% deduction of the charitable contribution, then a deduction for the $2,000 charitable contribution lowers the overall AGI to $29,000 (original $30,000 AGI minus ($2,000×50%) equals $29,000). Because the tax rules and regulations are established such that some tax events have varying effects depending on other circumstances related to the taxpayer's tax information, it is not a simple one-to-one ratio to calculate the effect of each tax event.

In particular and as used herein, applying the rules and regulations of the United States government taxing authority, tax events categorized in the credits category or the taxes, payments, and penalties category affect the refund/owe amount in a one-to-one (1:1) ratio, as noted above. Thus, if the credit is worth $1,000, then the refund/owe amount is raised by $1,000. Similarly, if the taxpayer made an estimated tax payment of $2,000, then the refund/owe amount is raised by $2,000. In embodiments of the invention and as set forth in step 122, determining the monetary amount by which each tax event affects the displayed modified refund/owe amount next generates a first intermediate refund/owe amount by calculating the refund/owe amount based only tax events categorized in the income category and the adjustments and deductions category. Thus, because tax events categorized in the credits category or the taxes, payments, and penalties category affect the refund/owe amount in a one-to-one (1:1) ratio, such events can be excluded from the refund/owe amount calculation without otherwise impacting how the income and adjustments and deductions affect the refund/owe amount.

Next, at step 124, a second intermediate refund/owe amount is calculated based only on tax events categorized in the income category. Thus, tax events in any of the adjustments and deductions category, the credits category, or the taxes, payments, and penalties category are excluded from the refund/owe amount calculation. It is noted that the second intermediate refund/owe amount, although based only on income tax events, will not always fully isolate the effect of income tax events on the modified refund/owe amount. In particular, depending on the tax circumstances of a particular taxpayer, the accurate effect of income tax events on the refund/owe amount is not completely known until evaluated against adjustments and deductions. As a generalized example, it is common for the tax rules and regulations of a government taxing authority to provide a personal exemption, e.g., $3,500, for most income levels. However, at high-level incomes, e.g., greater than $300,000, the personal exemption is phased out. But, if the taxpayer's adjustments and deductions lower the income amount to less than the phase-out level, e.g., $300,000, the taxpayer may then be able to take advantage of the personal exemption, which would in turn lower the income. Thus, if the effect of the income was calculated based only on the inputted income amount, this may not be an accurate representation for all taxpayers due to the effect adjustments and deductions can in turn have on income.

At step 126, a third intermediate refund/owe amount is calculated. The third intermediate refund/owe amount is a difference between the first and second intermediate refund/owe amounts. Because the first amount isolates the effect of income and adjustments and deductions, and the second amount isolates the effect of only income, then the third amount, which is the difference between the first and second amounts, isolates the effect of adjustments and deductions. Similarly, at step 128, the fourth intermediate refund/owe amount is calculated, which is a difference between the first and third intermediate refund/owe amounts. Because the first amount isolates the effect of income and adjustments and deductions, and the third amount isolates the effect of only adjustments and deductions, the fourth intermediate refund/owe amount, which is a difference between the first and third amounts, isolates the effect of income only. The above calculations may be performed for all inputted tax events to date, i.e., at the time of the refund/owe amount calculation. It is further noted that the computer program of embodiments of the invention may not display on the GUI each of the intermediate refund/owe amounts, but in alternative embodiments, any one or more of the intermediate refund/owe amounts may be displayed.

Referring to FIG. 1C, in alternative embodiments of the invention, the impact of each category on the refund/owe amount is calculated via different steps than set forth in steps 120-128 of FIG. 1B. As with the above-described process of FIG. 1B, a respective category for each tax event is first identified, as set forth in step 130. To determine the monetary amount by which each tax event affects the displayed modified refund/owe amount, a first alternative intermediate refund/owe amount is generated that is a difference between the modified refund/owe amount (i.e., the presently displayed or last calculated refund/owe amount) and a sum of a monetary amount associated with each respective tax event categorized in the credits category and the taxes, payments, and penalties category, as set forth in step 124. As such, embodiments sum all credit tax events and all taxes, payments, and penalties tax events because these categories of tax events affect the tax liability in a 1:1 ratio, as explained above. Thus, if the displayed modified refund/owe amount is $2,000, and the user subsequently enters tax event information for a tax credit worth $1,000, then the modified refund/owe amount will increase by $1,000, and this increase is directly attributable to the inputted credit. The sum of the monetary amount of tax events categorized in the credits category and the taxes, payments, and penalties category can then be subtracted from the modified refund/owe amount to obtain the first alternative intermediate refund/owe amount. This amount excludes any tax events categorized in the credits category and the taxes, payments, and penalties category and is representative of a refund/owe amount that accounts for only tax events categorized in the income category and the adjustments and deductions category. The first alternative intermediate refund/owe amount calculation essentially assumes that there are no tax events in the credits category and the taxes, payments, and penalties category and calculates the taxpayer's tax liability based only on tax events in the income category and the adjustments and deductions category. At this juncture in the calculation, the computer program does not, in embodiments of the invention, display on the GUI the first alternative intermediate refund/owe amount. Instead, this amount is merely used in the overall calculation process to determine the effect of each tax event. Moreover, the first alternative intermediate refund/owe amount is based on a calculation of the tax liability of the taxpayer using the tax events.

Referring to step 134 of FIG. 1C, embodiments of the invention next calculate a second alternative intermediate refund/owe amount based only on tax events categorized in the income category, the credits category, and the taxes, payments, and penalties category, such that the second alternative intermediate refund/owe amount excludes tax events categorized in the adjustments and deductions category. Thus, the refund/owe amount is calculated to specifically exclude tax events in the adjustment and deductions category. The purpose of doing so is to isolate the effect of the adjustments and deductions tax events on the currently displayed modified refund/owe amount. To summarize, at this juncture in the calculation, the first alternative intermediate refund/owe amount that accounts only for income and adjustments and deductions is known, and the second alternative intermediate refund/owe amount that accounts only for income, credits, and taxes, payments, and penalties is known. However, the refund/owe amount that accounts only for adjustments and deductions is not known. Similar to the first alternative intermediate refund/owe amount, in embodiments of the invention, the second alternative intermediate refund/owe amount is not displayed on the GUI but is merely a known value used in the overall calculation process.

Next and referring to step 136, a third alternative intermediate refund/owe amount is calculated, which is a difference between the second alternative intermediate refund/owe amount and a sum of the monetary amount associated with each respective tax event in the credits category and the taxes, payments, and penalties category. Because the second alternative intermediate refund/owe amount accounts only for tax events in the income category, the credits category, and the taxes, payments, and penalties category, and the difference is calculated between the second alternative intermediate refund/owe amount and the sum of the monetary amount associated with each respective tax event in the credits category and the taxes, payments, and penalties category, the third alternative intermediate refund/owe amount is representative of and accounts only for an effect of tax events in the income category. Similar to the first and second alternative intermediate refund/owe amounts, in embodiments of the invention, the third alternative intermediate refund/owe amount is not displayed on the GUI but is merely a known value used in the overall calculation process.

At this juncture in the calculation process, the effect of tax events in adjustments and deductions may be calculated by one of two steps. In a first alternative substep 138A, a fourth alternative intermediate refund/owe amount is calculated. The fourth alternative intermediate refund/owe amount is a difference between the first alternative intermediate refund/owe amount and the third alternative intermediate refund/owe amount, such that the fourth alternative intermediate refund/owe amount is representative of an effect of tax events in only the adjustments and deductions category. Essentially, the first alternative intermediate refund/owe amount that accounts only for tax events categorized in the income category and the adjustments and deductions category is subtracted from the third alternative intermediate refund/owe amount that accounts only for an effect of tax events in the income category. The difference is the monetary amount of the adjustments and deductions on the modified refund/owe amount. Similar to the first, second, and third alternative intermediate refund/owe amounts, in embodiments of the invention, the fourth alternative intermediate refund/owe amount is not displayed on the GUI but is merely a known value used in the overall calculation process.

An alternative substep to determining the effect of the tax events in the adjustments and deductions category is also illustrated in step 138B of FIG. 1C. In particular, the fourth alternative intermediate refund/owe amount may be calculated by taking a difference between the modified refund/owe amount and a sum of the third alternative intermediate refund/owe amount and the monetary amount associated with each respective tax event in the credits category and the taxes, payments, and penalties category, such that the fourth alternative intermediate refund/owe amount is representative of an effect of tax events in only the adjustments and deductions category. Thus, this substep 138B of determining an effect of adjustments and deductions on the modified refund/owe amount isolates the monetary effects of the other categories on the modified refund/owe amount, and subtracts the monetary effects of the other categories from the modified refund/owe amount, leaving only the effect of the adjustments and deductions tax events.

As noted above, performing steps 120-128 and the proposed alternative steps 130-138A,B obtains the known information of the effect each category of tax events has on the modified refund/owe amount. However, performing the steps does not obtain the effect each tax event within each category has on the modified refund/owe amount (unless, of course, there is only one tax event per category). Thus, embodiments of the invention perform a second set of steps to obtain the effect, and specifically the monetary effect, each tax event has the modified refund/owe amount. As also noted above, steps 120-128 and alternative steps 130-138A,B could not be performed, and instead, embodiments of the invention could isolate each tax event and calculate a refund/owe amount including and excluding each tax event so as to determine the effect of each tax event. From this information, the effect of each category of tax events could be determined by taking the sum of the monetary effects of all tax events within each category.

Turning now to FIG. 1D, embodiments of the invention determine the monetary amount by which each tax event, including the last received tax event, affects the modified refund/owe amount. As illustrated in step 140, embodiments of the invention obtain or calculate, as needed, a first category refund/owe amount that accounts for all tax events in the respective category. That is, if a particular category has three tax events categorized in it that affect the refund/owe amount, then step 140 calculates or otherwise determines the total monetary amount for the three tax events to obtain the monetary amount for the category attributable to the modified refund/owe amount.

Next, in step 142, embodiments of the invention calculate a second category refund/owe amount that excludes a single tax event in the respective category, which is referred to as an excluded tax event. For example, if a particular category has three tax events (TE1, TE2, and TE3), then step 140 determines the monetary amount for all three events, e.g., TE1+TE2+TE3 equals the first category refund/owe amount. Step 142, in contrast, excludes one of TE1, TE2, and TE3 from the calculation of the tax refund/owe amount, such that the second category refund/owe amount obtained from step 142 is either only TE1+TE2, TE1+TE3, or TE2+TE3, but not TE1+TE2+TE3. Thus, if the excluded tax event is TE1, then the second category refund/owe amount is TE2+TE3.

In step 144, a difference between the first category refund/owe amount and the second category refund/owe amount is calculated to obtain a tax event value for the excluded tax event. Because the first category refund/owe amount is the monetary effect of all tax events in the category, and the second category refund/owe amount is the monetary effect of all tax events in the category but the excluded tax event, then the difference between the first and second category refund/owe amounts isolates the monetary effect of the excluded tax event. The tax event value for the excluded tax event is thus the monetary amount by which the excluded tax event affects the modified refund/owe amount. In embodiments of the invention and to obtain a more accurate value for the excluded tax event, the refund/owe amounts calculated for both the first and second category refund/owe amounts include the tax events in all other categories other than the category being calculated. Thus, for example, if the monetary effect of a tax event in adjustments and deductions is being calculated, there are three tax events in adjustments and deductions (i.e., TE1A&D, TE2A&D, and TE3A&D), and TE1A&D is the excluded tax event, then calculation of the second category refund/owe amount accounts for all tax events inputted to the tax return preparation software except for TE1A&D.

It should be noted that there are alternative methods of isolating the monetary effect of a particular tax event. For example, instead of the first and second category refund/owe amounts being for all tax events (except the excluded tax event for the second category refund/owe amount), the first category refund/owe amount may be the amount calculated for the respective category in respective steps 122-128. For example, if the category is adjustments and deductions and the first category refund/owe amount is only for the tax events in the adjustments and deductions category and not for all inputted tax events, as described above, then the first category refund/owe amount for adjustments and deductions category was already determined in step 126. If the second category refund/owe amount is then calculated pursuant to steps 126 but excluding a single tax event in the respective category, the difference between the first and second category refund/owe amounts isolates the monetary effect of the excluded tax event.

Once the monetary effect of one of the tax events is known by performing steps 140-144, embodiments of the invention then iteratively perform steps 140-144 for each tax event in each respective category to obtain said tax event value for each tax event in each category, as set forth in step 146. As should be appreciated, the iterative process of performing the above-discussed steps in real time for each tax event is computationally prohibitive without use of the computing device. Thus, embodiments of the invention, as discussed above, perform steps 140-144 to isolate the effect of each category of tax events and each tax event in each category only upon receipt of a ROM generating event.

Embodiments of the invention thus determine, in real time and upon receipt of each ROM generating event, the effect of each tax event on the refund/owe amount displayed in the ROM. Moreover, embodiments of the invention isolate the effect each category and each tax event of each category has on either a currently displayed modified refund/owe amount or a final refund/owe amount by calculating a difference of the refund/owe amount with and without the respective tax event or category.

Turning now to FIGS. 4, 6, 8, and 10-12, embodiments of the invention display one or more reports that provide the explanation, including the monetary amount, of the tax event on each category, the modified refund/owe amount at any point in the tax interview, and the final refund/owe amount. As shown in the listed Figures, a graph may be illustrated that shows the positive or negative effect and monetary value for each category of tax events. The report may further include the category accounting that sets forth the total increase/decrease on the final refund/owe amount for each category (see, e.g., FIGS. 11 and 12). Additionally, each tax event that affected the final refund/owe amount is also listed. FIGS. 11-12 provide further views of various reports setting forth the effect of each category (FIG. 11) and each tax event (FIG. 12) on the taxpayer's final refund/owe amount, including a charting and comparison against prior year returns.

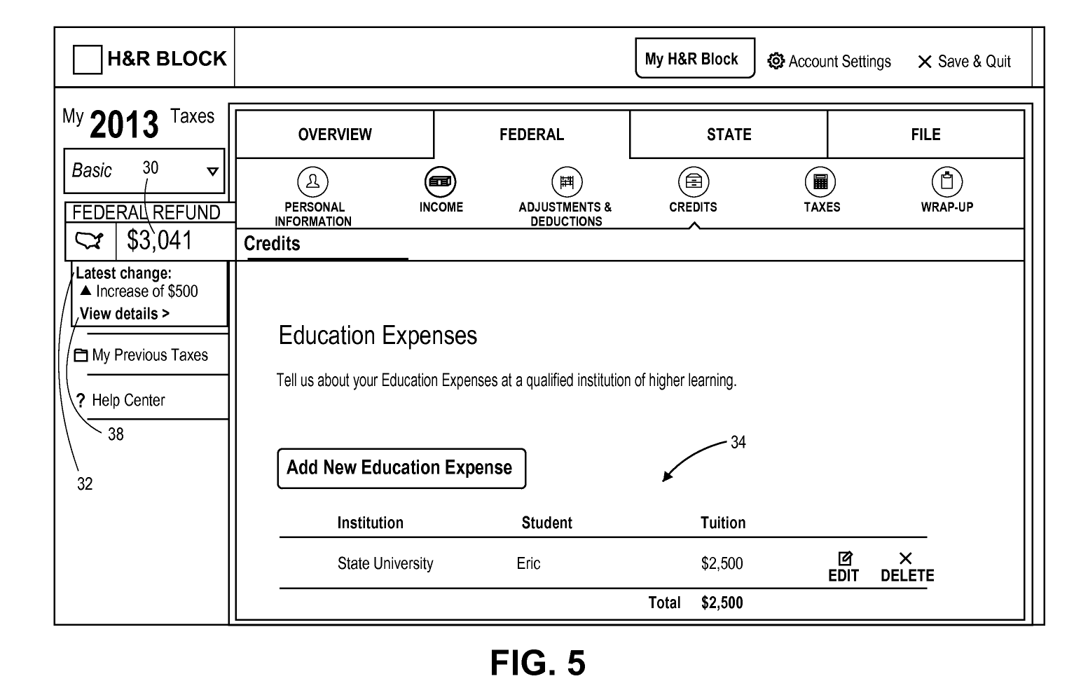

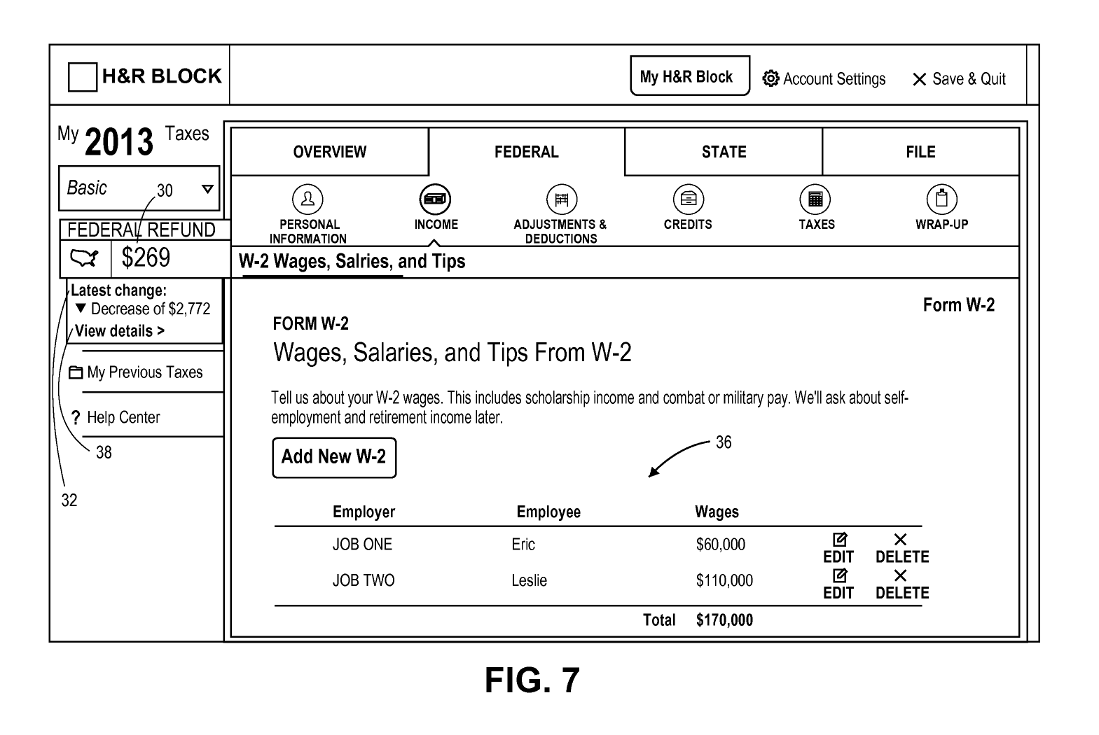

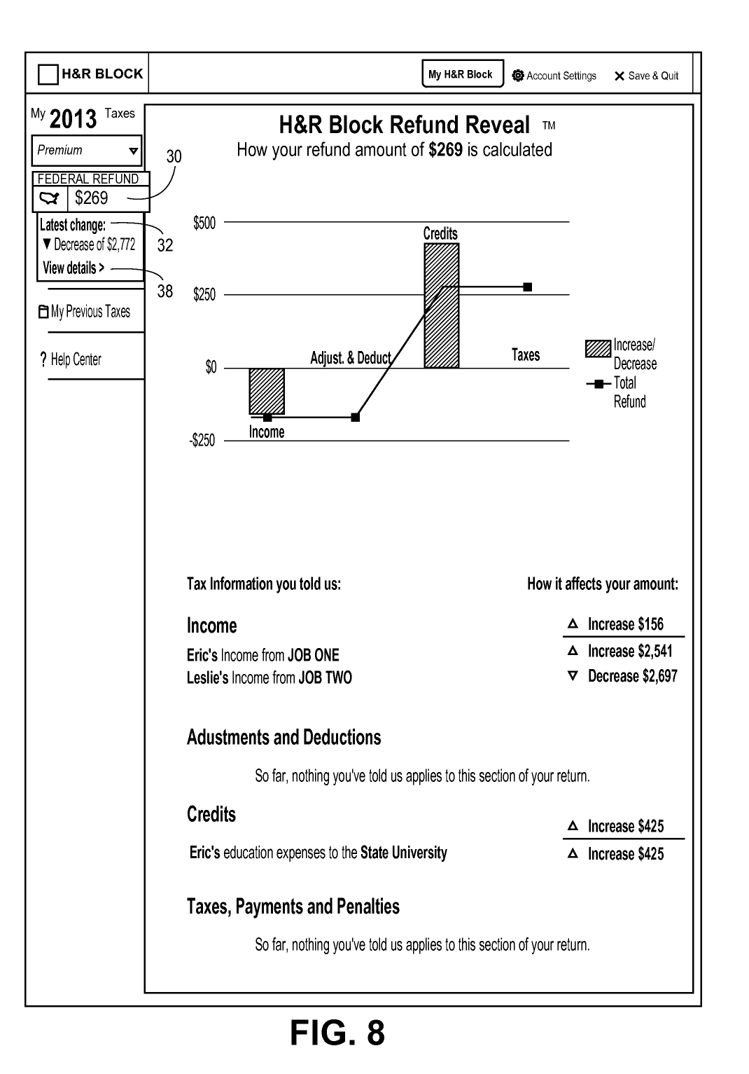

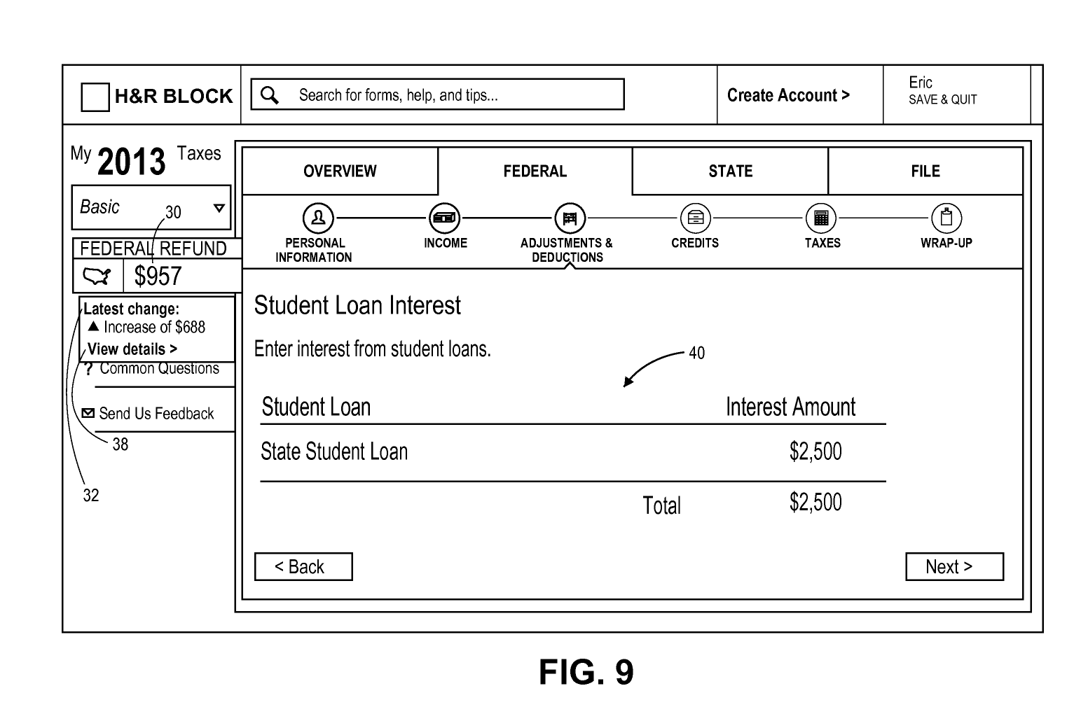

Turning now to FIGS. 3-10, a specific, non-limiting example of embodiments of the invention will be described. Referring to FIG. 3, the tax return preparation software presents the various tax categories and guides the user through the tax interview. In the screen capture of FIG. 3, the user is requested to enter income information from a Form W-2. At reference numeral (RN) 28, wages of $60,000 from Job One are added, which results in the ROM displaying a federal refund of $2,541 (see RN 30). Because this is the first tax event information entered that affects the displayed refund/owe amount, the latest change 32 to the ROM is shown as an increase of $2,541. FIG. 4 illustrates a report that the user may view at any time during the tax interview. The report displays the category and individual tax event accountings. Because only income information from Job One is entered at this point in the interview, the report shows the income category and an increase of $2,541 corresponding to the displayed ROM of $2,541. Turning to FIG. 5, the user decides to turn to the portion of the tax interview for the credits category. A Credit of an education expense is entered for tuition of $2,500 (see generally RN 34). The received education expense credit changes the federal refund by an increase of $500 (RN 32), such that the displayed ROM 30 is now $3,041. Similar to FIG. 3, FIG. 6 illustrates the category accounting and individual tax event accounting and corresponding effect of the Job One income and the education expense credit. Turning to FIG. 7, a second income, identified as Job Two, has wages of $110,000 (see generally RN 36). The receipt of this second income information significantly affects the refund/owe amount for this particular taxpayer. In particular, entry of this tax event information (i.e., the Job Two information) changes the displayed ROM from $3,041 to $269, for a decrease of $2,772. As illustrated in FIG. 8 and the commensurate category and individual tax event accountings for the received tax event information to date, the addition of the Job Two income decreased the displayed refund/owe amount. Moreover, the tax credit for the education expense only now affects the displayed refund/owe amount by $425, instead of the $500 increase illustrated in FIG. 6. FIG. 9 illustrates the tax interview in the adjustments and deduction category. The tax interview is requesting the user input any student loan interest, as generally shown at RN 40. As shown in FIG. 9, student loan interest in the amount of $2,500 is entered, which changes the displayed ROM from the previous amount of $269 to $957, for an increase of $688. As with the other tax interview questions and displayed ROM, the user may view details of the effect of the tax event on the ROM, which in embodiments will present a GUI similar to FIG. 10. In FIG. 10, the category accounting and individual tax event accounting set forth an explanation of the effect of each received tax event on the overall refund amount of $957.

The user may, at any time during the interview, view details of the change in the ROM. The user's selection of a “View Details” link 38 or other similar request for the latest refund/owe amount and/or effect of at least one tax event is a ROM generating event. Selection of the View Details link 38 may, in embodiments, present to the user the GUIs illustrated in FIGS. 4, 6, and 8 or other similar category and tax event accountings. Thus, should the user select to view details, the user may be presented with the category and/or individual tax event accounting. Alternatively, a pop-up or other short-form GUI may be presented to provide a brief explanation of the effect of the last inputted tax event on the displayed ROM.

Embodiments of the invention may further provide one or more suggestions to the user or taxpayer for decreasing the taxpayer's overall tax liability. A computer program, a method, and a system for providing suggestions to a taxpayer for decreasing a tax liability are described in U.S. Pat. No. 8,706,580, entitled “Method, System, and Computer Program for Predicting Tax Liabilities and Benefits,” and issued Apr. 22, 2014 (“the '580 patent”). The disclosure of the '580 patent is herein incorporated by reference in its entirety.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. At least one non-transitory computer readable storage medium with a computer program stored thereon for providing tax return preparation software that calculates, in generally real time, an effect a tax event has on a taxpayer's tax refund amount or tax owed amount (collectively “refund/owe amount”), wherein the tax event affects the taxpayer's tax liability and is categorized in one of the following categories: income; adjustments and deductions; credits; and taxes, payments, and penalties, wherein the computer program instructs at least one processing element to perform the steps of:
presenting, via a graphical user interface, a plurality of requests for tax event information related to the taxpayer's tax liability;
in response to said plurality of requests for tax event information related to the taxpayer's tax liability, successively receiving a plurality of inputted tax event information;
displaying, via the graphical user interface, a refund/owe meter (ROM) that presents a calculated refund/owe amount based on at least a portion of the plurality of inputted tax event information;
identifying a plurality of ROM generating events;
in response to identifying each ROM generating event, calculating a modified refund/owe amount and presenting the modified refund/owe amount via the ROM,
wherein the modified refund/owe amount is based on a cumulatively entered tax event information;
determining, in real time and upon receipt of each ROM generating event, said effect each successively received tax event has on the refund/owe amount, including determining a monetary amount by which a last received tax event effects the modified refund/owe amount; and
displaying, on the graphical user interface, a category tax event accounting for each category of said income; adjustments and deductions; credits; and taxes, payments, and penalties,
wherein the category tax event accounting provides an explanation to the taxpayer of how each category affects the taxpayer's refund/owe amount, and
wherein the category tax event accounting is a sum of a monetary amount by which all tax events in the respective category affect the refund/owe amount.

2. The at least one computer readable storage medium of claim 1, wherein said step of determining said effect each said successively received tax event has on the modified refund/owe amount includes the steps of (i) determining an effect each category of tax events has on the modified refund/owe amount; and (ii) once the effect of each category of tax events is determined, performing said step of determining said effect each said successively received tax event has on the modified refund/owe amount using the determined effect of each category of tax events.

3. The at least one computer readable storage medium of claim 2, wherein said step of determining said monetary amount by which said last received tax event affects the refund/owe amount includes the steps of:
identifying a respective category for each tax event successively received at a time of performing said step of determining the monetary amount by which the last received tax event affects the refund/owe amount;
generating a first intermediate refund/owe amount based only on tax events categorized in the income category and the adjustments and deductions category, such that the first intermediate refund/owe amount excludes tax events categorized in the credits category and the taxes, payments, and penalties category;
calculating a second intermediate refund/owe amount based only on tax events categorized in the income category, such that the second intermediate refund/owe amount excludes tax events categorized in the adjustments and deductions category, the credits category, and the taxes, payments, and penalties category;
calculating a third intermediate refund/owe amount that is a difference between the first and second intermediate refund/owe amounts, such that the third intermediate refund/owe amount is representative of an effect of tax events categorized only in the adjustment and deductions category; and
calculating a fourth intermediate refund/owe amount that is a difference between the first intermediate refund/owe amount and the third intermediate refund/owe amount, such that the fourth intermediate refund/owe amount is representative of an effect of tax events only in the income category.

4. The at least one computer readable storage medium of claim 2, wherein said step of determining said monetary amount by which said last received tax event affects the refund/owe amount includes the steps of:
identifying a respective category for each tax event successively received at a time of performing said step of determining the monetary amount by which the last received tax event affects the refund/owe amount; and
generating a first intermediate refund/owe amount that is a difference between the modified refund/owe amount and a sum of a monetary amount associated with each respective tax event categorized in the credits category and the taxes, payments, and penalties category,
wherein each tax event categorized in either of the credits category or the taxes, payments, and penalties category affects the taxpayer's tax liability by said monetary amount,
wherein the first intermediate refund/owe amount excludes any tax events categorized in the credits category and the taxes, payments, and penalties category and is representative of a refund/owe amount that accounts for only tax events categorized in the income category and the adjustments and deductions category.

5. The at least one computer readable storage medium of claim 4, wherein said step of determining said monetary amount by which said last received tax event affects the modified refund/owe amount includes the step of:
calculating a second intermediate refund/owe amount based only on tax events categorized in the income category, the credits category, and the taxes, payments, and penalties category, such that the second intermediate refund/owe amount excludes tax events categorized in the adjustments and deductions category;
calculating a third intermediate refund/owe amount that is a difference between the second intermediate refund/owe amount and a sum of the monetary amount associated with each respective tax event in the credits category and the taxes, payments, and penalties category, such that the third intermediate refund/owe amount is representative of an effect of tax events only in the income category; and
calculating a fourth intermediate refund/owe amount that is a difference between the first intermediate refund/owe amount and the third intermediate refund/owe amount, such that the fourth intermediate refund/owe amount is representative of an effect of tax events in only the adjustments and deductions category.

6. The at least one computer readable storage medium of claim 4, wherein said step of determining said monetary amount by which said last received tax event affects the modified refund/owe amount includes the step of:
calculating a second intermediate refund/owe amount based only on tax events categorized in the income category, the credits category, and the taxes, payments, and penalties category, such that the second intermediate refund/owe amount excludes tax events categorized in the adjustments and deductions category;
calculating a third intermediate refund/owe amount that is a difference between the second intermediate refund/owe amount and a sum of the monetary amount associated with each respective tax event in the credits category and the taxes, payments, and penalties category, such that the third intermediate refund/owe amount is representative of an effect of tax events only in the income category; and
calculating a fourth intermediate refund/owe amount that is a difference between the modified refund/owe amount and a sum of the third intermediate refund/owe amount and the monetary amount associated with each respective tax event in the credits category and the taxes, payments, and penalties category, such that the fourth intermediate refund/owe amount is representative of an effect of tax events in only the adjustments and deductions category.

7. The at least one computer readable storage medium of claim 3, wherein said step of determining said monetary amount by which said last received tax event affects the modified refund/owe amount includes the steps of:
(a) obtaining a first category refund/owe amount that accounts for all tax events in the respective category;
(b) calculating a second category refund/owe amount that excludes a single tax event in the respective category;
(c) calculating a difference between the first category refund/owe amount and the second category refund/owe amount to obtain a tax event value for the excluded tax event,
wherein the tax event value is a monetary amount by which the excluded tax event affects the modified refund/owe amount,
wherein both the first and second category refund/owe amounts include the tax events in all other categories other than the category being calculated; and
(d) iteratively performing steps (a), (b), and (c) for each tax event in each respective category to obtain said tax event value for each tax event in each category.

8. The at least one computer readable storage medium of claim 1, wherein the ROM generating event is selected from the group consisting of (i) receipt of pre-defined tax event information; (ii) request by the user to generate the modified refund/owe amount; (iii) receipt of each successively-inputted tax event; and (iv) completion of receipt of all tax event information.

9. The at least one computer readable storage medium of claim 1, wherein the computer program instructs the at least one processing element to perform the step of displaying, on the graphical user interface, an individual tax event accounting for each successively inputted tax event that monetarily affects the refund/owe amount, wherein the individual tax event accounting provides an explanation to the taxpayer of how each tax event affects the taxpayer's refund/owe amount.

10. At least one non-transitory computer readable storage medium with a computer program stored thereon for providing tax return preparation software that calculates, in generally real time, an effect a tax event has on a taxpayer's tax refund amount or tax owed amount (collectively “refund/owe amount”), wherein the tax event affects the taxpayer's tax liability and is categorized in one of the following categories: income; adjustments and deductions; credits; and taxes, payments, and penalties, wherein the computer program instructs at least one processing element to perform the steps of:
presenting, via a graphical user interface, a plurality of requests for tax event information related to the taxpayer's tax liability;
presenting, via the graphical user interface, a request for tax event information relating to at least one tax event within the income category;
receiving said tax event information relating to at least one tax event within the income category;
after receiving said tax event information relating to at least one tax event within the income category, calculating a tentative refund/owe amount and displaying the tentative refund/owe amount on the interface;
after calculating the tentative refund/owe amount and displaying the tentative refund/owe amount on the interface, presenting successive requests for tax event information relating to tax events within any of the categories;
successively receiving said requested tax event information relating to tax events within any of the categories;
after at least some of each successively received tax event information relating to tax events within any of the categories, calculating and displaying, in generally real time, a modified refund/owe amount,
wherein the modified refund/owe amount is based on a last received tax event information relating to tax events within any of the categories;
wherein the modified refund/owe amount dynamically changes in generally real time based on said last received tax event information of said successively received tax event information relating to tax events within any of the categories;
determining, in real time and in response to the calculating and displaying the modified refund/owe amount, said effect each successively received tax event has on the modified refund/owe amount, including determining a monetary amount by which said last received tax event affects the modified refund/owe amount;
receiving information indicative of receipt of all tax event information for all categories; and
in response to receiving information indicative of said receipt of all tax event information for all categories, displaying a final refund/owe amount indicating a final monetary amount of a refund/owe amount.

11. The at least one computer readable storage medium of claim 10, wherein said step of determining said effect each said successively received tax event has on the modified refund/owe amount includes the steps of (i) determining an effect each category of tax events has on the modified refund/owe amount; and (ii) once the effect of each category of tax events is determined, performing said step of determining said effect each said successively received tax event has on the modified refund/owe amount using the determined effect of each category of tax events.

12. The at least one computer readable storage medium of claim 11, wherein said step of determining said monetary amount by which said last received tax event affects the refund/owe amount includes the steps of:
identifying a respective category for each tax event successively received at a time of performing said step of determining the monetary amount by which the last received tax event affects the refund/owe amount;
generating a first intermediate refund/owe amount based only on tax events categorized in the income category and the adjustments and deductions category, such that the first intermediate refund/owe amount excludes tax events categorized in the credits category and the taxes, payments, and penalties category;
calculating a second intermediate refund/owe amount based only on tax events categorized in the income category, such that the second intermediate refund/owe amount excludes tax events categorized in the adjustments and deductions category, the credits category, and the taxes, payments, and penalties category;
calculating a third intermediate refund/owe amount that is a difference between the first and second intermediate refund/owe amounts, such that the third intermediate refund/owe amount is representative of an effect of tax events categorized only in the adjustment and deductions category; and
calculating a fourth intermediate refund/owe amount that is a difference between the first intermediate refund/owe amount and the third intermediate refund/owe amount, such that the fourth intermediate refund/owe amount is representative of an effect of tax events only in the income category.

13. The at least one computer readable storage medium of claim 12, wherein said step of determining said monetary amount by which said last received tax event affects the modified refund/owe amount includes the steps of:
(a) obtaining a first category refund/owe amount that accounts for all tax events in the respective category;
(b) calculating a second category refund/owe amount that excludes a single tax event in the respective category;
(c) calculating a difference between the first category refund/owe amount and the second category refund/owe amount to obtain a tax event value for the excluded tax event,
wherein the tax event value is a monetary amount by which the excluded tax event affects the modified refund/owe amount,
wherein both the first and second category refund/owe amounts include the tax events in all other categories other than the category being calculated; and
(d) iteratively performing steps (a), (b), and (c) for each tax event in each respective category to obtain said tax event value for each tax event in each category.

14. The at least one computer readable storage medium of claim 11, wherein said step of determining said monetary amount by which said last received tax event affects the modified refund/owe amount includes the steps of:
identifying a respective category for each tax event successively received at a time of performing said step of determining the monetary amount by which the last received tax event affects the modified refund/owe amount;
generating a first intermediate refund/owe amount that is a difference between the modified refund/owe amount and a sum of a monetary amount associated with each respective tax event categorized in the credits category and the taxes, payments, and penalties category,
wherein each tax event categorized in either of the credits category or the taxes, payments, and penalties category affects the taxpayer's tax liability by said monetary amount,
wherein the first intermediate refund/owe amount excludes any tax events categorized in the credits category and the taxes, payments, and penalties category and is representative of a refund/owe amount that accounts for only tax events categorized in the income category and the adjustments and deductions category;
calculating a second intermediate refund/owe amount based only on tax events categorized in the income category, the credits category, and the taxes, payments, and penalties category, such that the second intermediate refund/owe amount excludes tax events categorized in the adjustments and deductions category; and
calculating a third intermediate refund/owe amount that is a difference between the second intermediate refund/owe amount and a sum of the monetary amount associated with each respective tax event in the credits category and the taxes, payments, and penalties category, such that the third intermediate refund/owe amount is representative of an effect of tax events only in the income category.

15. The at least one computer readable storage medium of claim 14, wherein said step of determining said monetary amount by which said last received tax event affects the modified refund/owe amount includes the step of:
calculating a fourth intermediate refund/owe amount that is a difference between the first intermediate refund/owe amount and the third intermediate refund/owe amount, such that the fourth intermediate refund/owe amount is representative of an effect of tax events in only the adjustments and deductions category.

16. The at least one computer readable storage medium of claim 14, wherein said step of determining said monetary amount by which said last received tax event affects the modified refund/owe amount includes the step of:
calculating a fourth intermediate refund/owe amount that is a difference between the modified refund/owe amount and a sum of the third intermediate refund/owe amount and the monetary amount associated with each respective tax event in the credits category and the taxes, payments, and penalties category, such that the fourth intermediate refund/owe amount is representative of an effect of tax events in only the adjustments and deductions category.

16. The at least one computer readable storage medium of claim 10,
wherein the computer program instructs the at least one processing element to perform the step of displaying, on the graphical user interface, an individual tax event accounting for each individual tax event, wherein the individual tax event accounting provides an explanation to the taxpayer of how each tax event affects the taxpayer's final refund/owe amount, including a monetary amount by which the tax event affects the final refund/owe amount,
wherein the computer program instructs the at least one processing element to perform the step of displaying, on the graphical user interface, a category tax event accounting for each category of said income; adjustments and deductions; credits; and taxes, payments, and penalties,
wherein the category tax event accounting provides an explanation to the taxpayer of how each category affects the taxpayer's final refund/owe amount, and
wherein the category tax event accounting is a sum of a monetary amount by which all tax events in the respective category affect the final refund/owe amount.

17. At least one non-transitory computer readable storage medium with a computer program stored thereon for providing tax return preparation software that calculates, in generally real time, an effect a tax event has on a taxpayer's tax refund amount or tax owed amount (collectively “refund/owe amount”), wherein the tax event affects the taxpayer's tax liability and is categorized in one of the following categories: income; adjustments and deductions; credits; and taxes, payments, and penalties, wherein the computer program instructs at least one processing element to perform the steps of:
presenting, via a graphical user interface, a plurality of requests for tax event information related to the taxpayer's tax liability;
presenting, via the graphical user interface, a request for tax event information relating to at least one tax event within the income category;
receiving said tax event information relating to at least one tax event within the income category;
after receiving said tax event information relating to at least one tax event within the income category, calculating a tentative refund/owe amount and displaying the tentative refund/owe amount on the interface;
after calculating the tentative refund/owe amount and displaying the tentative refund/owe amount on the interface, presenting successive requests for tax event information relating to tax events within any of the categories;
successively receiving said requested tax event information relating to tax events within any of the categories;
after each successively received tax event information relating to tax events within any of the categories, calculating and displaying, in generally real time, a modified refund/owe amount,
wherein the modified refund/owe amount is based on a last received tax event information relating to tax events within any of the categories;
wherein the modified refund/owe amount dynamically changes in generally real time based on said last received tax event information of said successively received tax event information relating to tax events within any of the categories;
determining, in real time and as each tax event information is successively received, said effect each successively received tax event has on the modified refund/owe amount, including determining a monetary amount by which said last received tax event affects the modified refund/owe amount, wherein said step further comprises the substeps of:
(a) identifying a respective category for each tax event successively received at a time of performing said step of determining the monetary amount by which the last received tax event affects the modified refund/owe amount;
(b) obtaining a first category refund/owe amount that accounts for all tax events in the respective category;
(c) calculating a second category refund/owe amount that excludes a single tax event in the respective category;
(d) calculating a difference between the first category refund/owe amount and the second category refund/owe amount to obtain a tax event value for the excluded tax event,
wherein the tax event value is a monetary amount by which the excluded tax event affects the modified refund/owe amount,
wherein both the first and second category refund/owe amounts include the tax events in all other categories other than the category being calculated; and
(e) iteratively performing steps (b), (c), and (d) for each tax event in each respective category to obtain said tax event value for each tax event in each category.

18. The at least one computer readable storage medium of claim 17,
wherein the computer program instructs the at least one processing element to perform the step of displaying, on the graphical user interface, an individual tax event accounting for each individual tax event, wherein the individual tax event accounting provides an explanation to the taxpayer of how each tax event affects the taxpayer's final refund/owe amount, including a monetary amount by which the tax event affects the final refund/owe amount,
wherein the computer program instructs the at least one processing element to perform the step of displaying, on the graphical user interface, a category tax event accounting for each category of said income; adjustments and deductions; credits; and taxes, payments, and penalties,
wherein the category tax event accounting provides an explanation to the taxpayer of how each category affects the taxpayer's final refund/owe amount, and
wherein the category tax event accounting is a sum of a monetary amount by which all tax events in the respective category affect the final refund/owe amount.
